(19) United States
(12) Patent Application Publication
(10) Pub. No.: US 2026/0289820 A1
(43) Pub. Date: Sep. 24, 2026

(54) METHODS AND SYSTEMS FOR ONLINE EXTRINSIC CALIBRATION OF A CAMERA

(71) Applicant: Harman International Industries, Incorporated, Stamford, CT (US)

(72) Inventors: Rongqiang Qian, Shanghai (CN); Qi LV, Shanghai (CN)

(21) Appl. No.: 19/473,780

(22) PCT Filed: May 3, 2023
(86) PCT No.: PCT/US2023/020875

§ 371 Date: Oct. 8, 2025

(51) Int. Cl. G06T 7/80

(52) U.S. Cl. CPC G06T 7/80; G06T 2207/20084; G06T 2207/30268

(57) ABSTRACT

Systems and methods are disclosed for performing an extrinsic calibration of an in-cabin camera of a vehicle. In one example, a method for performing an extrinsic calibration of a camera of a vehicle comprises receiving a plurality of images from the camera of the vehicle; detecting and describing a plurality of two-dimensional (2D) feature points of the images using a trained neural network; mapping the detected 2D feature points to three-dimensional (3D) feature points stored in a feature point library generated using the trained neural network; estimating a set of extrinsic parameters of the camera using the mapped 3D feature points; and performing the extrinsic calibration based on the set of extrinsic parameters.

### FIELD

The present disclosure relates to systems and methods for performing an extrinsic calibration of a camera, such as an in-cabin camera of a vehicle.

### BACKGROUND

An Advanced Driver Assistance System (ADAS) of a vehicle may rely on a Driver Monitoring System (DMS) and/or an Occupant Monitoring System (OMS) to adjust operation of a vehicle. Cameras are widely applied in various DMS and OMS systems. The cameras may extract information regarding an in-cabin environment, including states, attributes, and poses of a driver and occupants, as well as external features of an environment of the vehicle. States and attributes of the driver and occupants may often be extracted based on intrinsic parameters (e.g., local coordinates) of cameras, whereas driver and occupant pose data may be estimated based on camera position and extrinsic parameters of the camera. Since obtaining information regarding the driver and occupant pose data relies on the extrinsic parameters of the camera, flexible and accurate online extrinsic calibration of the cameras is desired.

However, existing methods for online extrinsic calibration of cameras are hindered by complex setups and high costs. Further, the existing methods may rely on supervised feature point detector and descriptor training algorithms that rely on heavy manual annotation. Additionally, the supervised feature point detector training algorithms may have a poor detection rate, and resulting feature point descriptors may have weak feature representation.

### SUMMARY

The current disclosure at least partially addresses one or more of the above identified issues by a method for performing an extrinsic calibration of a camera, comprising receiving a plurality of images from the camera of the vehicle; detecting and describing a plurality of two-dimensional (2D) feature points of the images using a trained neural network; mapping the detected 2D feature points to three-dimensional (3D) feature points stored in a feature point library generated using the trained neural network, estimating a set of extrinsic parameters of the camera using the mapped 3D feature points, and performing the extrinsic calibration based on the set of extrinsic parameters. The feature point library may be developed offline, for example, at a lab of a manufacturer of the vehicle. The extrinsic calibration of the camera may be performed online at the vehicle, during vehicle operation.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which some embodiments described herein pertain. Although methods and materials similar or equivalent to those described herein can be used in the practice or testing of embodiments described herein, exemplary methods and/or materials are described below. In case of conflict, the patent specification, including definitions, will control. In addition, the materials, methods, and examples are illustrative only and are not intended to be necessarily limiting.

Implementation of the method and/or system of some embodiments described herein can involve performing or completing selected tasks automatically. Moreover, according to actual instrumentation and equipment of embodiments of the method and/or system described herein, several selected tasks could be implemented by hardware, by software or by firmware or by a combination thereof using an operating system.

### BRIEF DESCRIPTION OF THE SEVERAL VIEWS OF THE DRAWINGS

Some embodiments are herein described, by way of example only, with reference to the accompanying drawings. With specific reference now to the drawings in detail, it is stressed that the particulars are shown by way of example and for purposes of illustrative discussion of embodiments described herein. In this regard, the description taken with the drawings makes apparent to those skilled in the art how embodiments described herein may be practiced.

In the drawings:

FIG. 1 shows a vehicle system including one or more cameras, according to one or more embodiments of the present disclosure;

FIG. 2 shows a block diagram of a computing system of a vehicle configured to calibrate a camera of the vehicle using a trained neural network model, according to one or more embodiments of the present disclosure;

FIG. 3 shows a schematic diagram of a calibration procedure for the camera, according to one or more embodiments of the present disclosure;

FIG. 4 shows a block diagram of an exemplary embodiment of an calibration system configured to calibrate the camera;

FIG. 5 shows a block diagram of an exemplary embodiment of a model training system for training the neural network model;

FIG. 6 is an architecture diagram of an neural network model which may be trained in the training system of FIG. 5, according to an exemplary embodiment;

FIG. 7 shows a method for performing online extrinsic calibration of the camera, according to an exemplary embodiment;

FIG. 8 shows a method for automatically generating labels for a pair of feature points and/or background points of an image, according to an exemplary embodiment;

FIG. 9 shows a method for training a neural network model using the extrinsic calibration network training system of FIG. 5, according to an exemplary embodiment.

FIG. 10 shows a method for building a feature point library using a trained neural network model, according to an exemplary embodiment;

FIG. 11 shows a method for determining extrinsic parameters of the camera, according to an exemplary embodiment;

FIG. 12 shows a method for an ADAS for adjusting an operation of a vehicle based on images received from an in-cabin camera of the vehicle, according to one or more embodiments of the present disclosure;

FIG. 13 shows an example image of feature points detected in a reference object placed in a cabin of the vehicle, according to one or more embodiments of the present disclosure; and

FIG. 14 shows an example image of a chessboard used by a chessboard detection algorithm, according to one or more embodiments of the present disclosure.

### DETAILED DESCRIPTION

Advanced Driver Assistance Systems (ADAS) are developed to adapt and enhance operation of vehicles to increase quality of driving and the driving experience. An ADAS monitors an inside and outside environment of vehicle using various types of sensors, such as camera, lidar, radar, and ultrasonic sensors. The sensor data may be processed by an in-vehicle computing system to extract information regarding the vehicle operator/occupant(s), and implement actions based on the information. The actions may include alerting the operator via an audio or visual notification, or controlling the throttle, brake, or steering of the vehicle.

The ADAS may rely on a Driver Monitoring System (DMS) and/or an Occupant Monitoring System (OMS). The DMS includes a set of advanced safety features that applies output from in-cabin sensors (including cameras) to detect and track the physical state (e.g., vehicle operator experiencing drowsiness) or mental state (e.g., vehicle operator is distracted). Further, the DMS may alert the vehicle operator when the vehicle operator is experiencing physical states or mental states that are not suitable for operation of the vehicle. In comparison with the DMS, the OMS may monitor an entirety of an in-cabin environment. The OMS includes features such as seat belt detection, smart airbag deployment, left object warning, and forgotten child warning. Therefore, increasing the efficiency of the DMS and/or the OMS to detect visual information regarding the vehicle operator and/or occupant(s) may increase the efficiency of ADAS to implement remediation measures to increase quality of vehicle operation.

Due to their ability to provide visual information, cameras have been widely applied in various DMS and OMS. By implementing machine learning (ML) and deep learning (DL) techniques, DMS and OMS systems can extract information regarding the in-cabin environment, such as states, attributes and poses of the vehicle operator and/or occupant(s). States and attributes of the vehicle operator and/or occupant(s) may be extracted based on local coordinates of cameras, whereas poses of the vehicle operator and/or occupant(s) may be estimated using extrinsic camera parameters meaning, a position and orientation of the camera in three-dimensional (3D) coordinates of the real world.

The extrinsic parameters have two components: rotation (R), and translation (t). Specifically, the extrinsic parameters of the camera include three rotation angles, meaning rotation about the x-, y- and z-axes (e.g., role, pitch, and yaw) and three translation values (e.g., a 3D vector with x, y, and z translation values). Therefore, calibration of the extrinsic parameters of cameras (e.g., referred to herein as extrinsic calibration) may increase the efficiency of DMS and OMS to detect states, attributes, and poses of the vehicle operator and/or occupant(s).

The extrinsic calibration may be performed offline (e.g., not during daily driving), or the extrinsic calibration may be performed online (e.g., performed while a vehicle operator is operating the vehicle). Offline calibration of extrinsic parameters typically relies on specifically designed and placed reference objects, such as a chessboard, and may be performed in a factory or workshop. Online calibration of extrinsic parameters does not rely on specifically designed and placed reference objects, and is performed based on images of a driver/occupant of the vehicle during operation of the vehicle. The goal of online extrinsic calibration is to estimate extrinsic parameters (R, t) of a camera referenced on a vehicle coordinate system based on the images of the driver or occupant of the vehicle, where the feature points include pixel locations/locations on a face or body of the driver or occupant.

During offline calibration of extrinsic parameters of a camera of a vehicle, a DL calibration model may be trained on a plurality of images to detect feature points, and predict corresponding descriptions of the feature points. For the purposes of this disclosure, feature points are image pixels with distinctive features (e.g., visual characteristics) of a subject that enable the subject or a pose of the subject to be identified. The feature point has 2D coordinates in the image.

The descriptions of the feature points may contain information regarding visual characteristics surrounding the feature point. The description may be a vector with float/integer values. The trained DL calibration model is used to build a feature point library comprising the detected 2D feature points and descriptions, and corresponding 3D feature points and descriptions. The library may be implemented as a reference or lookup table, where any 2D feature point may be mapped to a corresponding 3D feature point in the real world during online extrinsic calibration by matching the description of the 2D feature point to a corresponding description of the 3D feature point in the feature point library. Compared to offline extrinsic calibration, online extrinsic calibration has increased flexibility and accuracy for a life-cycle of DMS and OMS.

A method is proposed herein for online extrinsic calibration of in-cabin cameras based on feature-matching, which may robustly and accurately perform extrinsic calibration of a mono camera of an in-cabin environment. The system includes three key aspects: a feature points detector and descriptor; feature matching; and a camera pose estimator. The feature points detector and descriptor are based on one or more DL calibration models (e.g., neural networks) that robustly and accurately detect feature points and extract a corresponding feature point description. The DL calibration models may be trained without manual annotation or labeling, which may reduce a training time and/or cost of the neural networks. Consequently, with the feature matching correspondences between feature points included in a library and feature points acquired via the camera, a camera pose can be estimated based on known Perspective-n-Point (PnP) algorithms.

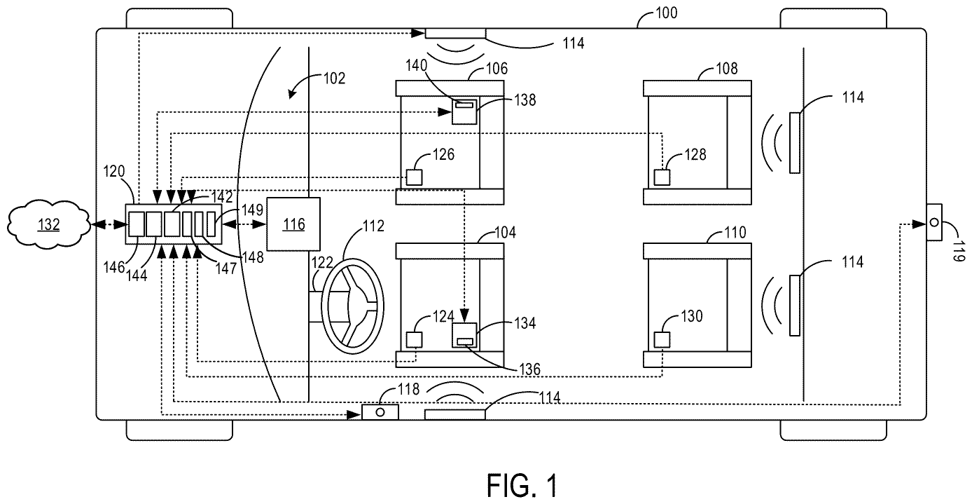

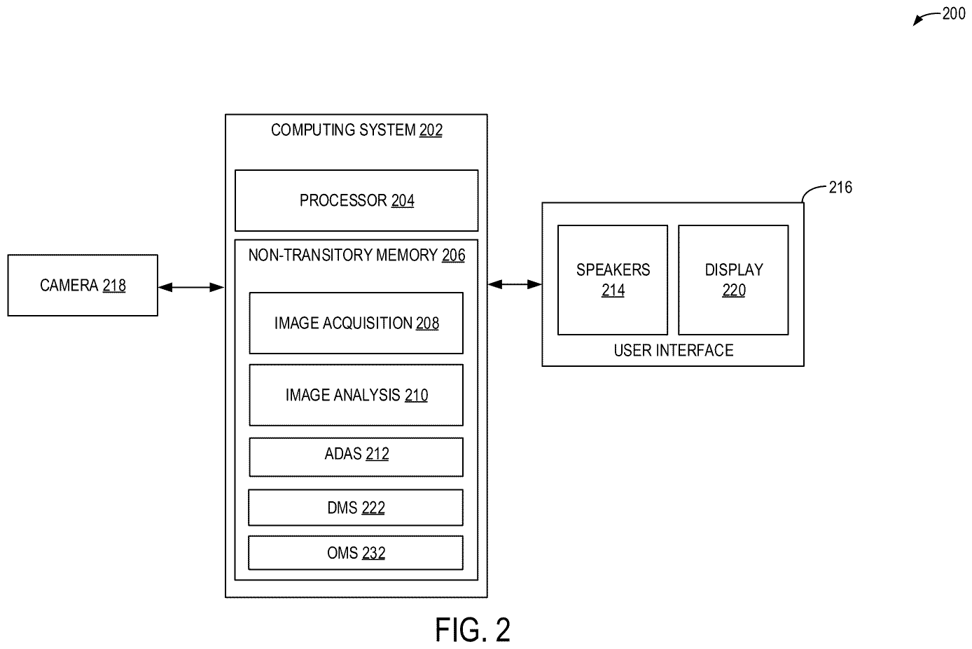

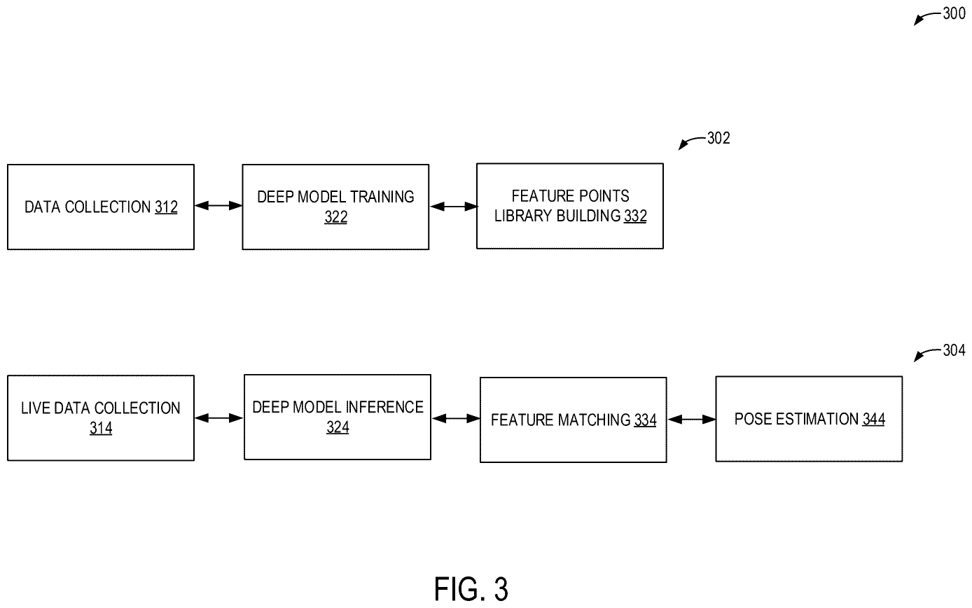

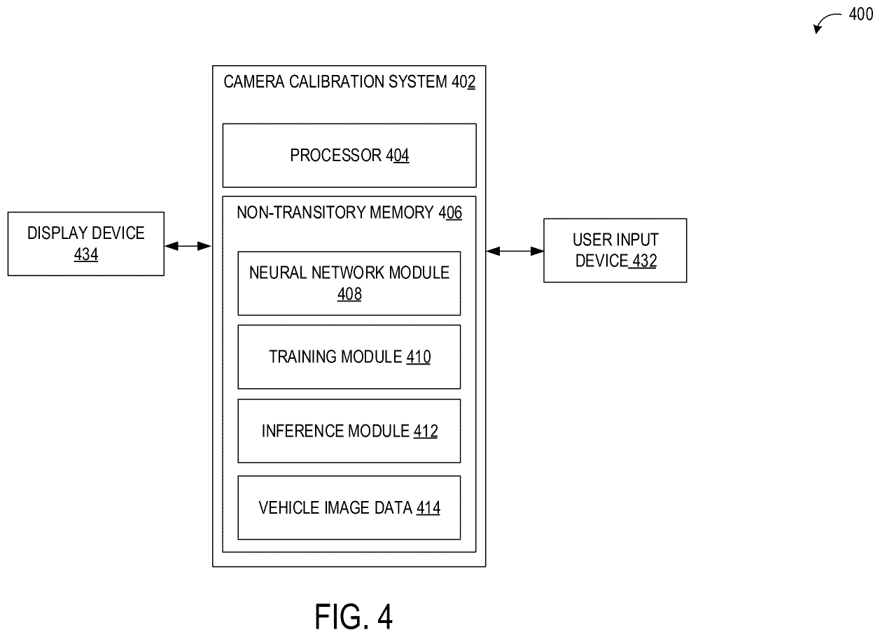

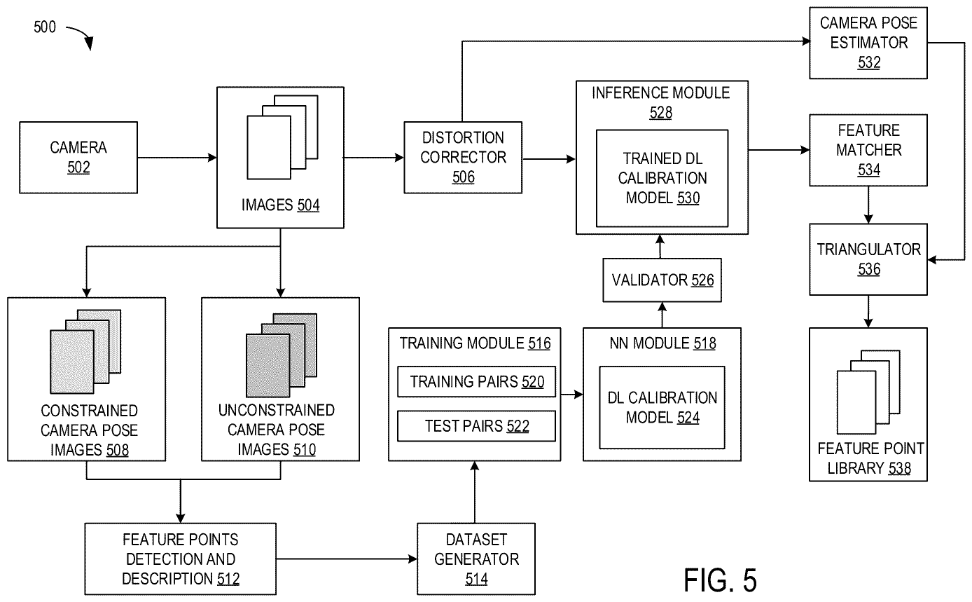

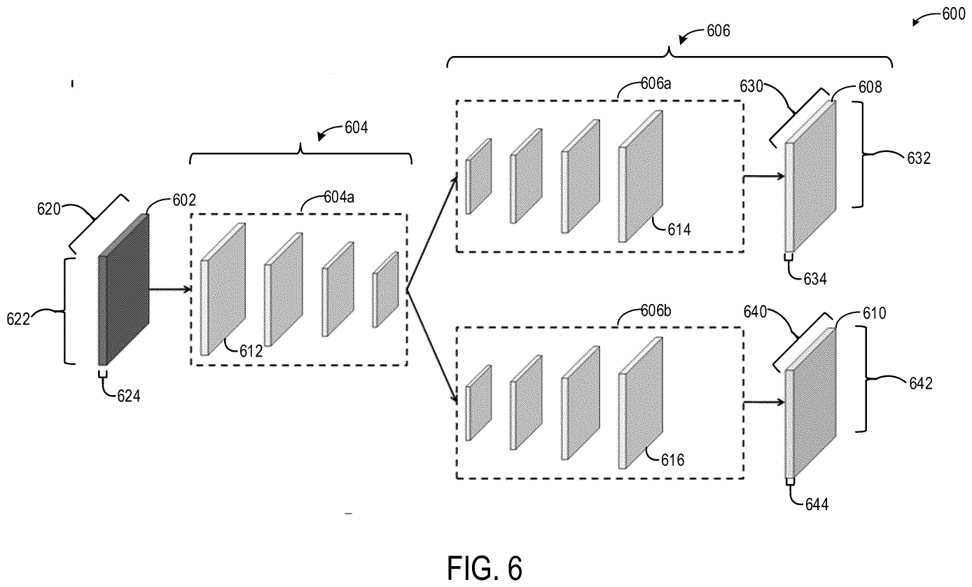

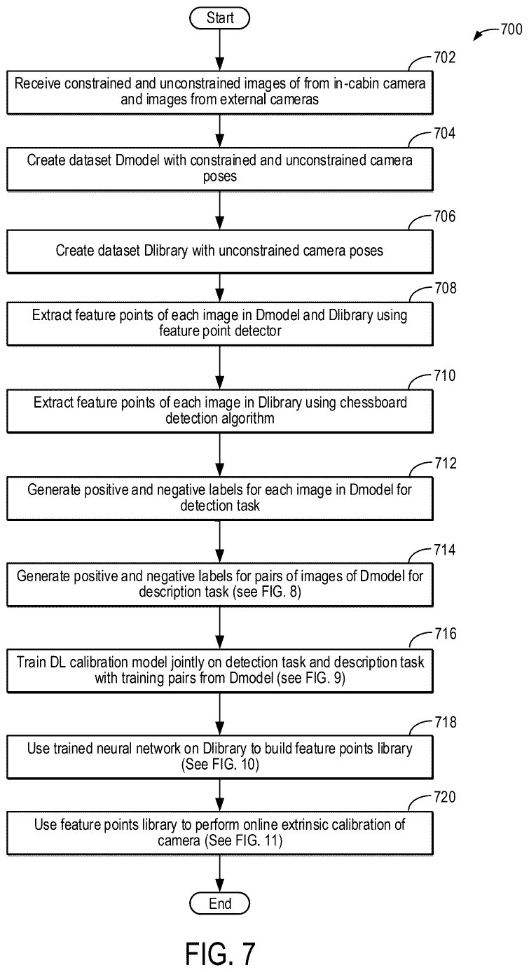

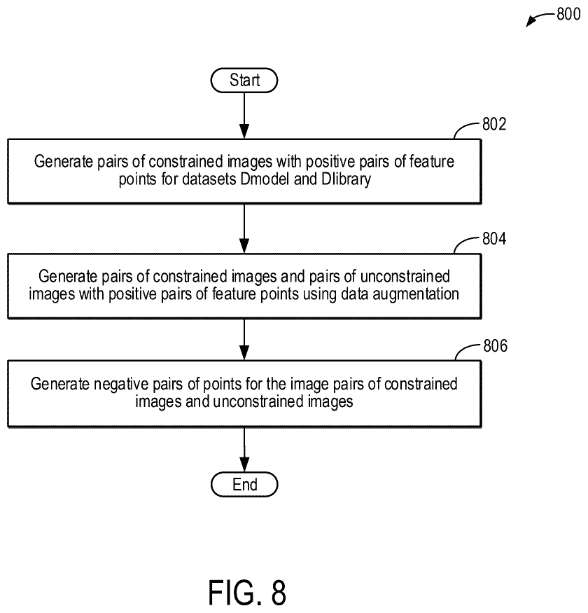

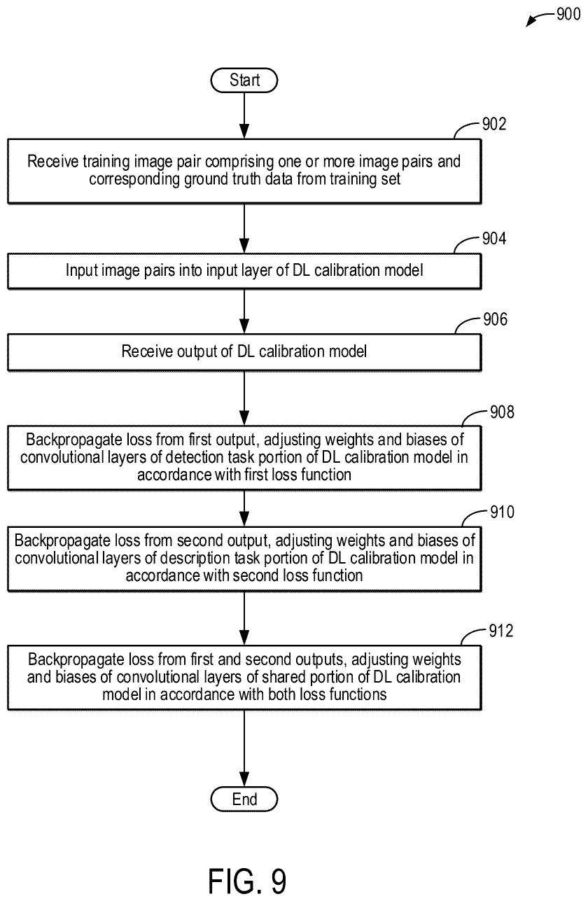

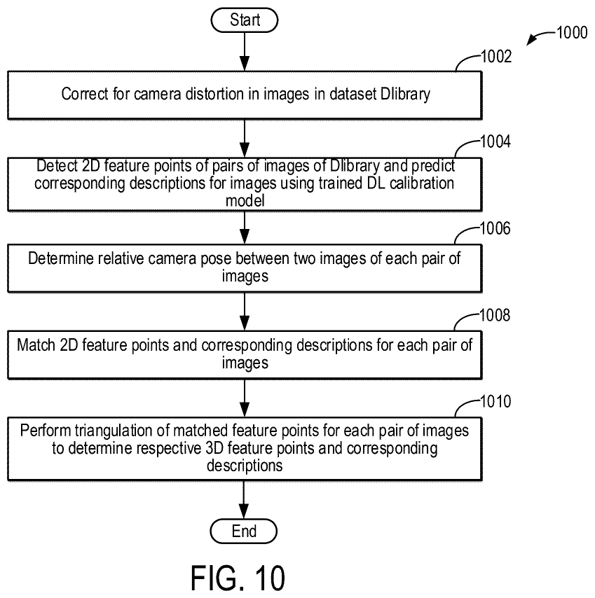

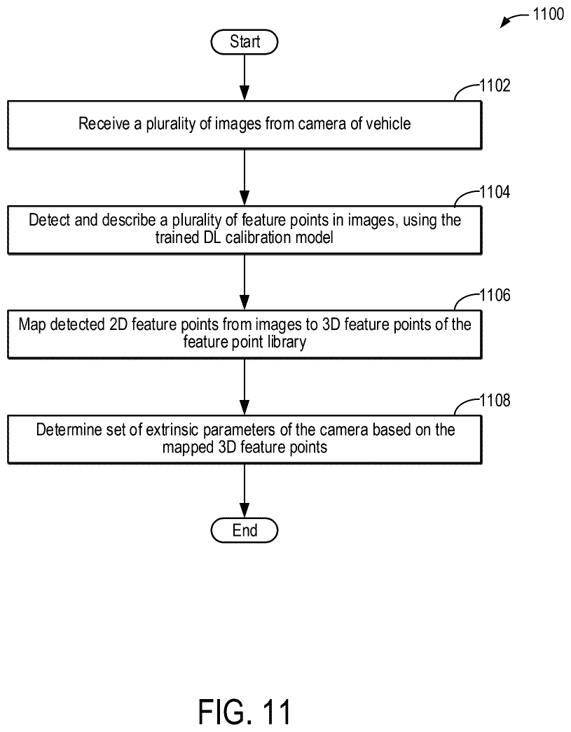

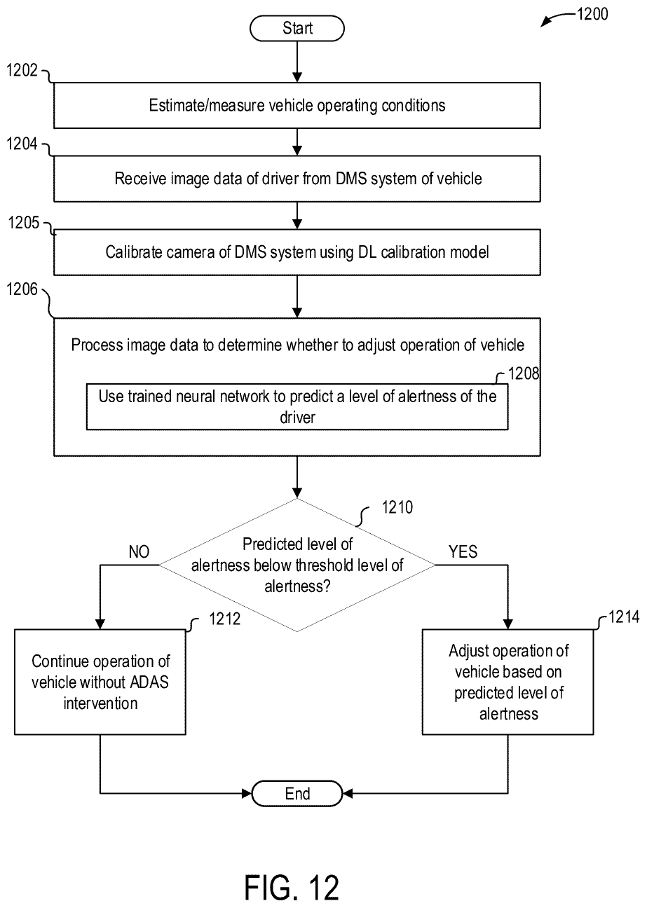

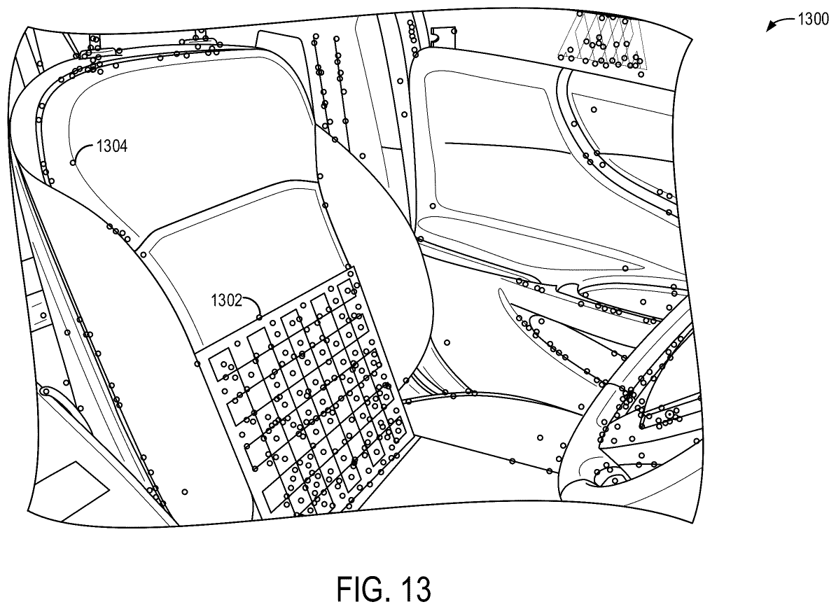

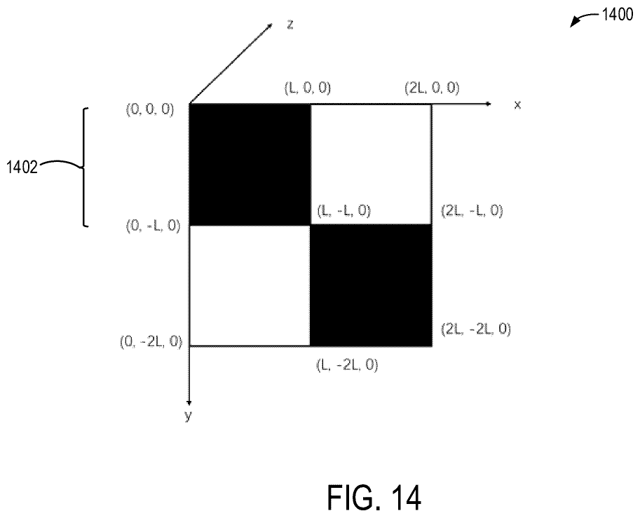

FIG. 1 illustrates an exemplary vehicle with an extrinsic calibration system integrated into a computer system of the vehicle. FIG. 2 depicts an extrinsic camera calibration system used to determine extrinsic parameters of an in-cabin camera. A general extrinsic calibration procedure using the extrinsic camera calibration system is shown in FIG. 3. An image processing system used to train a DL calibration model is illustrated in FIG. 4. FIG. 5 shows an DL calibration model training system for training the DL calibration model. An architecture for a neural network implemented in the DL calibration model training system is depicted in FIG. 6. Calibration of the online extrinsic camera calibration system is performed according to the method described with respect to FIG. 7. FIG. 8 shows a method for automatic generation of labels for training the DL calibration model. The DL calibration model may be trained according to the method of FIG. 9. The trained DL calibration model may be used to build a feature point library according to the method described in reference to FIG. 10. Extrinsic parameters of the in-cabin camera may be determined using the method of FIG. 11. A trained DL calibration model may be used to implement an ADAS intervention according to the method described in FIG. 12. FIG. 13 shows an exemplary reference object (e.g., a chessboard) placed in a cabin of the vehicle used during calibration, where the chessboard is shown in detail in FIG. 14.

Turning now to the figures, FIG. 1 schematically shows an exemplary vehicle 100. The vehicle 100 includes a dashboard 102, a driver seat 104, a first passenger seat 106, a second passenger seat 108, and a third passenger seat 110. In other examples, the vehicle 100 may include more or fewer passenger seats. The driver seat 104 and the first passenger seat 106 are located in a front of the vehicle, proximate to the dashboard 102, and therefore may be referred to as front seats. The second passenger seat 108 and the third passenger seat 110 are located at a rear of the vehicle and may be referred to as back (or rear) seats.

Additionally, the vehicle 100 includes a plurality of integrated speakers 114, which may be arranged around a periphery of the vehicle 100. In some embodiments, the integrated speakers 114 are electronically coupled to an electronic control system of the vehicle, such as to a computing system 120, via a wired connection. In other embodiments, the integrated speakers 114 may wirelessly communicate with the computing system 120. As an example, an audio file may be selected by an occupant of the vehicle 100, such as a driver passenger, via a user interface 116, and the selected audio file may be projected via the integrated speakers 114. In some examples, audio alerts may be generated by the computing system 120 and also may be projected by the integrated speakers 114, such as will be elaborated herein.

The vehicle 100 includes a steering wheel 112 and a steering column 122, through which the driver may input steering commands for the vehicle 100. The vehicle 100 further includes one or more of camera 118. The camera 118 may be one camera of a plurality of cameras. In the embodiment shown in FIG. 1, the camera 118 is positioned to the side of the driver seat 104, which may aid in monitoring the driver in profile. However, in other examples, the camera 118 may be positioned in other locations in the vehicle, such as on the steering column 122, directly in front of the driver seat 104. Further, the camera 118 may be positioned to the side of the passenger seats 106, 108, and 110 or directly in front of the passenger seats 106, 108, and 110.

Additionally, in the embodiment shown in FIG. 1, the camera 119 is positioned on the exterior of the back end of the vehicle 100, which may aid in monitoring the position of the vehicle 100 in a lane and/or monitor the position of the vehicle 100 relative to other vehicles and/or the surrounding environment, as some examples. In other examples, the camera 119 may be positioned in other locations in the vehicle, such as the exterior of the front end of the vehicle 100 or the sides of the vehicle 100.

The camera 118 may include one or more optical (e.g., visible light) cameras, one or more infrared (IR) cameras, or a combination of optical and IR cameras having one or more view angles. In some examples, the camera 118 may have interior view angles as well as exterior view angles. In some examples, the camera 118 may include more than one lens and more than one image sensor. For example, the camera 118 may include a first lens that directs light to a first, visible light image sensor (e.g., a charge-coupled device or a metal-oxide-semiconductor) and a second lens that directs light to a second, thermal imaging sensor (e.g., a focal plane array), enabling the camera 118 to collect light of different wavelength ranges for producing both visible and thermal images. In some examples, the camera 118 may further include a depth camera and/or sensor, such as a time-of-flight camera or a LiDAR sensor.

In some examples, the camera 118 may be a digital camera configured to acquire a series of images (e.g., frames) at a programmable frequency (e.g., frame rate) and may be electronically and/or communicatively coupled to the computing system 120. Further, the camera 118 may output acquired images to the computing system 120 in real time so that they may be processed in real time by the computing system 120 and/or a computer network. As used herein, the term “real time” denotes a process that occurs without intentional delay (e.g., substantially at the time of occurrence). In other examples, the camera 118 may acquire images to determine states, attributes, and poses of the driver or passenger (e.g., occupant), such as will be elaborated herein.

The vehicle 100 may further include a driver seat sensor 124 coupled to or within the driver seat 104 and a passenger seat sensor 126 coupled to or within the first passenger seat 106. The back seats may also include seat sensors, such as a passenger seat sensor 128 coupled to the second passenger seat 108 and a passenger seat sensor 130 coupled to the third passenger seat 110. The driver seat sensor 124 and the passenger seat sensor 126 may each include one or a plurality of sensors, such as a weight sensor, a pressure sensor, and one or more seat position sensors that output a measurement signal to the computing system 120. For example, the output of the weight sensor or pressure sensor may be used by the computing system 120 to determine whether or not the respective seat is occupied, and if occupied, a weight of a person occupying the seat. As another example, the output of the one or more seat position sensors may be used by the computing system 120 to determine one or more of a seat height, a longitudinal position with respect to the dashboard 102 and the back seats, and an angle (e.g., tilt) of a seat back of the corresponding seat.

In some examples, the vehicle 100 further includes a driver seat motor 134 coupled to or positioned within the driver seat 104 and a passenger seat motor 138 coupled to or positioned within the first passenger seat 106. Although not shown, in some embodiments, the back seats may also include seat motors. The driver seat motor 134 may be used to adjust the seat position, including the seat height, the longitudinal seat position, and the angle of the seat back of the driver seat 104 and may include an adjustment input 136. For example, the adjustment input 136 may include one or more toggles, buttons, and switches. The passenger seat motor 138 may be used to adjust the seat position, including the seat height, the longitudinal seat position, and the angle of the seat back of the first passenger seat 106 and may include an adjustment input 140. the adjustment input 140 may include one or more toggles, buttons, and switches. Although not shown, in some embodiments, the back seats may be adjustable in a similar manner.

The computing system 120 may receive inputs via the user interface 116 as well as output information to the user interface 116. The user interface 116 may be included in a digital cockpit, for example, and may include a display and one or more input devices. The one or more input devices may include one or more touchscreens, knobs, dials, hard buttons, and soft buttons for receiving user input from a vehicle occupant.

The computing system 120 includes a processor 142 configured to execute machine readable instructions stored in a memory 144. The processor 142 may be single core or multi-core, and the programs executed by processor 142 may be configured for parallel or distributed processing. In some embodiments, the processor 142 is a microcontroller. The processor 142 may optionally include individual components that are distributed throughout two or more devices, which may be remotely located and/or configured for coordinated processing. In some embodiments, one or more aspects of the processor 142 may be virtualized and executed by remotely-accessible networked computing devices configured in a cloud computing configuration. For example, the computing system 120 may be communicatively coupled with a wireless network 132 via a transceiver 146, and the computing system 120 may communicate with the networked computing devices via the wireless network 132.

The computing system 120 may include a DMS 147, which may monitor a driver of the vehicle 100. For example, the camera 118 may be located at the front of the vehicle 100 (e.g., on dashboard 102) or on a side of the vehicle 100 next to the driver seat 104, and may be positioned to view a face of the driver. The DMS may detect facial features of the driver. In some embodiments, the DMS 147 may be used to retrieve a driver profile of the driver based on the facial features, which may be used to customize a position of the driver seat 104, steering wheel 112, and/or other components or software of the vehicle 100.

The computing system 120 may include an OMS 148, which may monitor one or more passengers of the vehicle 100. For example, the camera 118 may be located at a side of the vehicle 100 next to one or more of passenger seats 106, 108, and 110, and may be positioned to view a face of a passenger of the vehicle.

The computing system 120 may include an ADAS 149, which may provide assistance to the driver based at least partially on the DMS 147. For example, ADAS 149 may receive facial expression data from the DMS 147, and the ADAS 149 may process the facial expression data to provide the assistance to the driver. For example, the ADAS 149 may process the facial expression data to determine whether the driver appears tired, or stressed. In response to detecting a tired or stressed condition of the driver, the ADAS 149 may alert the driver, or play music, or perform a different action to address the tired or stressed condition of the driver. In some embodiments, DMS 147 and/or OMS 148 may be integrated into ADAS 149.

In various embodiments trained ML or DL calibration model may be integrated into the DMS 147, OMS 148, or the ADAS 149 that may facilitate detection of facial features or expressions. The trained ML or DL calibration model may utilize sensor and/or camera data from camera 118 to determine whether ADAS intervention is warranted, for example. More particularly, the trained ML or DL calibration model may be trained to identify distinctive features (e.g., visual characteristics) of a subject that enable the subject to be identified and/or interpret a facial expression or pose of the subject. As described in greater detail herein, the trained ML or DL calibration model may rely on a prior extrinsic calibration of camera 118, which may enable a pose of a vehicle operator and/or occupant(s) to be more readily identified by the ADAS.

Additionally or alternatively, the computing system 120 may directly communicate with the networked computing devices via short-range communication protocols, such as Bluetooth®. In some embodiments, the computing system 120 may include other electronic components capable of carrying out processing functions, such as a digital signal processor, a field-programmable gate array (FPGA), or a graphic board. In some embodiments, the processor 142 may include multiple electronic components capable of carrying out processing functions. For example, the processor 142 may include two or more electronic components selected from a plurality of possible electronic components, including a central processor, a digital signal processor, a field-programmable gate array, and a graphics board. In still further embodiments, the processor 142 may be configured as a graphical processing unit (GPU), including parallel computing architecture and parallel processing capabilities.

Further, the memory 144 may include any non-transitory tangible computer readable medium in which programming instructions are stored. As used herein, the term “tangible computer readable medium” is expressly defined to include any type of computer readable storage. The example methods described herein may be implemented using coded instruction (e.g., computer readable instructions) stored on a non-transitory computer readable medium such as a flash memory, a read-only memory (ROM), a random-access memory (RAM), a cache, or any other storage media in which information is stored for any duration (e.g. for extended period time periods, permanently, brief instances, for temporarily buffering, and/or for caching of the information).

Computer memory of computer readable storage mediums as referenced herein may include volatile and non-volatile or removable and non-removable media for a storage of electronically formatted information, such as computer readable program instructions or modules of computer readable program instructions, data, etc. that may be stand-alone or as part of a computing device. Examples of computer memory may include any other medium which can be used to store the desired electronic format of information and which can be accessed by the processor or processors or at least a portion of a computing device. In various embodiments, the memory 144 may include an SD memory card, an internal and/or external hard disk, USB memory device, or a similar modular memory.

Further still, in some examples, the computing system 120 may include a plurality of sub-systems or modules tasks with performing specific functions related to performing image acquisition and analysis. As used herein, the terms “system,” “unit,” or “module” may include a hardware and/or software system that operates to perform one or more functions. For example, a module, unit, or system may include a computer processor, controller, or other logic-based device that performs operations based on instructions stored on a tangible and non-transitory computer readable storage medium, such as a computer memory. Alternatively, a module, unit, or system may include a hard-wired device that performs operations based on hard-wired logic of the device. Various modules or units shown in the attached figures may represent the hardware that operates based on software or hardwired instructions, the software that directs hardware to perform the operations, or a combination thereof. For example, as will be elaborated herein with respect to FIGS. 2-13, the computing system 120 may perform an online extrinsic calibration of the camera 118. Images received from the camera 118 may be input into a trained neural network model, which may be trained according to FIG. 9, to detect and describe feature points of the in-cabin environment from which extrinsic parameters of the camera 118 may be estimated based on feature matching via a feature point library developed offline.

FIG. 2 shows an in-cabin camera calibration system 200 comprising a computing system 202 of a vehicle communicatively coupled to a camera 218, in accordance with an embodiment. The camera 218 provides image data to the computing system 202. The camera 218 may be similar to, or the same as, the camera 118 of FIG. 1, and the computing system 202 may be a non-limiting version of the computing system 120 of FIG. 1. Computing system 202 includes a processor 204 configured to execute machine readable instructions stored in non-transitory memory 206. Processor 204 may be single core or multi-core, and the programs executed thereon may be configured for parallel or distributed processing. In some embodiments, the processor 204 may optionally include individual components that are distributed throughout two or more devices, which may be remotely located and/or configured for coordinated processing. In some embodiments, one or more aspects of the processor 204 may be virtualized and executed by remotely-accessible networked computing devices configured in a cloud computing configuration.

Non-transitory memory 206 includes an image acquisition module 208, an image analysis module 210, and an advanced driver assistance system (ADAS) module 212. The ADAS module 212 may include DMS module 222 and OMS module 232 that monitor a vehicle operator and occupant(s), respectively. The image acquisition module 208 may send and receive data with the camera 218. For example, the image acquisition module 208 may control acquisition settings of the camera 218, such as aperture, light sensitivity, focal depth, field of view, shutter speed, frame rate, etc. In some examples, the camera 218 may operate at a frame rate in a range between 4-24 frames per second to substantially continuously capture images of a vehicle interior. In other examples, the frame rate may be lower, such as one frame per second or per multiple seconds (e.g., 30-60 seconds), or higher (e.g., 30 frames per second). As one example, the frame rate may be selected based on a processing speed of the image analysis module 210 so that each image may be fully analyzed before the image analysis module 210 receives a next image in the sequence.

Further, the image acquisition module 208 may update the acquisition settings of the camera 218 based on feedback received from the image analysis module 210. For example, the image analysis module 210 may determine that the images acquired by the camera 218 are too dark and update one or more of the aperture, the light sensitivity, and the shutter speed at the image acquisition module 208 accordingly.

The image analysis module 210 may access images/videos (e.g., an image library) stored in memory and analyze the images received from the camera 218 in real-time to identify one or more features within each of the received image. As one example, the image analysis module 210 may receive a plurality of images from the camera 218. The plurality of images may be utilized to train a neural network to detect and describe feature points, where for the purposes of this disclosure, feature points are pixel locations of distinctive features (e.g., visual characteristics) of a subject that enable the subject or a position/pose of the subject to be identified. The feature points may be utilized to build a feature point library for feature points matching, as described in greater detail below in FIG. 10.

Additionally, the image analysis module 210 may receive online images from the camera 218. The images may be input into a trained neural network model to detect and describe feature points of the images, which may be matched with the feature point library to determine extrinsic parameters of the camera 218 during an online extrinsic calibration process. Online extrinsic calibration of the camera 218 may increase the accuracy of quality of images used for algorithms utilized in the ADAS module 212 that determine states, attributes, and poses of a vehicle operator and/or occupants.

Further, it may be understood that in some examples, the image analysis module 210 may be included in the in-vehicle computing system 202 or accessed via a user-provided mobile computing system, such as a smartphone, computer, or tablet. As another example, the image analysis module 210 may be included via a networked computing system such as a cloud computer or a similar computing environment and accessed remotely (e.g., via a wireless network, such as the wireless network 132 shown in FIG. 1). As such, although the image analysis module 210 is shown within the computing system 202 in the example shown in FIG. 2, in other embodiments, at least portions of the image analysis module 210 may be stored in computing devices and/or networks outside of the computing system 202 that are communicatively coupled to the computing system 202.

The vehicle may include a user interface 216, which may include one or more speakers 214 and a display 220. The ADAS 212 and/or the DMS 222 may detect specific states, attribute, and poses of the driver, and may notify the occupant using a user interface 216. As one example, the ADAS module 212 may interface with the user interface 216 to output an alert via a display 220 and/or speakers 214. The speakers 214 may be in-vehicle speakers, such as the integrated speakers 114 of FIG. 1, or speakers of the smartphone running the companion app. Similarly, the display 220 may be integrated in the vehicle (e.g., in a dashboard of the vehicle) or may be a display of the smartphone running the companion app. For example, the display 220 may output alert messages/symbols, and the speakers 214 may play alert sounds/prompts.

Referring now to FIG. 3, a schematic calibration diagram 300 shows a two stage process for performing an extrinsic calibration of a camera of a vehicle, such as the camera 118 of the vehicle 100 in FIG. 1, and/or camera 218 of FIG. 2. The two stage process includes a first stage 302 for training a DL neural network model and building a library of feature points of images collected using the camera, and a second stage 304 for performing the online extrinsic calibration of the in-cabin camera at the vehicle using the trained neural network model and the feature point library. The first stage 302 may be performed offline, meaning, at a lab or factory, and not during operation of a vehicle. The second stage 302 may be performed online, meaning, at and during operation of the vehicle. The first stage 302 includes a data collection step 312, a deep model training step 322, and a feature point library building step 332. The second stage 304 includes a live data collection step 314, a deep model inference step 324, a feature matching step 334, and a pose estimation step 344.

During the first stage 302, data collection step 312 includes acquiring images from an in-cabin camera, such as camera 118 of FIG. 1, for training a DL calibration model. The acquired images may include images of a specifically designed and placed reference object, such as a chessboard placed, for example, in a driver's seat. In some embodiments, external images may be acquired by an external camera, such as camera 119 of FIG. 1, for training the DL calibration model. Data collection step 312 further includes sorting the vehicle images into various vehicle image sub-datasets. Deep model training step 322 includes automatically generating labels for the vehicle images of the image sub-datasets and feature point/background point pairs, and training the DL calibration model to predict a probability of a location in an image being a 2D feature point as a first output, and predict a description for the location as a second output, which may include information regarding visual characteristics surrounding the location. Feature point library building step 332 includes building a library of corresponding 3D feature points and descriptions based on each 2D feature point and description, and using the trained DL calibration model.

With regards to the second stage 304, live data collection step 314 includes acquiring images of a vehicle operator and/or occupant(s) from the in-cabin camera during operation of the vehicle. Deep model inference step 324 includes detecting feature points and generating a corresponding description for each detected feature point using the trained DL calibration model. Feature matching step 334 includes matching a 2D feature point of an image acquired during operation of the vehicle with a 3D feature point in the library, based on the extracted feature point description. Pose estimation step 344 includes using the 2D and 3D feature points and descriptions of the image to estimate the extrinsic parameters of the camera. First stage 302 and second stage 304 are described in greater detail below in reference to FIGS. 4-14.

Referring to FIG. 4, an image processing system 400 is shown, in accordance with an embodiment, where image processing system 400 includes a camera calibration system 402. Image processing system 400 is incorporated into a computing system independent from vehicle 100, (e.g., not the computing system 120 of FIG. 1). For example, image processing system 400 may be installed on a server.

A camera calibration system 402 may be operably/communicatively coupled to a user input device 432 and a display device 434. The user input device 432 may comprise the user interface 115 of the computing system, while the display device 434 may comprise the display device 118 of the computing system, at least in some examples.

A camera calibration system 402 includes a processor 404 configured to execute machine readable instructions stored in non-transitory memory 406. Processor 404 may be single core or multi-core, and the programs executed thereon may be configured for parallel or distributed processing. In some embodiments, the processor 404 may optionally include individual components that are distributed throughout two or more devices, which may be remotely located and/or configured for coordinated processing. In some embodiments, one or more aspects of the processor 404 may be virtualized and executed by remotely-accessible networked computing devices configured in a cloud computing configuration.

Non-transitory memory 406 may store a neural network module 408, a network training module 410, an inference module 412, and vehicle image data 414. The neural network module 408 may include at least a DL calibration model, and instructions for implementing the DL calibration model to detect feature points and generate descriptions for the feature points, as described in greater detail below. Neural network module 408 may include trained and/or untrained neural networks and may further include various data, or metadata pertaining to the one or more neural networks stored therein.

Non-transitory memory 406 may further store a training module 410, which comprises instructions for training one or more of the neural networks stored in neural network module 408. Training module 410 may include instructions that, when executed by the processor 404, cause an camera calibration system 402 to conduct one or more of the steps of method 700 for preparing and calibrating an in-cabin calibration system, method 800 for labeling training data in a training dataset, method 900 for training the neural network model with the training dataset, and method 1000 for building a feature point library discussed in more detail below in reference to FIGS. 7-10, respectively. In some embodiments, training module 410 includes instructions for implementing one or more gradient descent algorithms, applying one or more loss functions, and/or training routines, for use in adjusting parameters of one or more neural networks of neural network module 408.

Non-transitory memory 406 also stores an inference module 412 that comprises instructions for testing new data with the trained DL calibration model. After the DL calibration model has been trained, the trained DL calibration model may be used by a vehicle computing system (e.g., computing system 120) to perform extrinsic online calibration of a camera, as described in FIG. 11.

Non-transitory memory 406 further stores vehicle image data 414. Vehicle image data 414 may include for example, vehicle images acquired via an in-cabin camera and via an external camera. For example, the vehicle image data 414 may store images acquired via the in-cabin camera and via the external camera for different vehicles. In some embodiments, vehicle image data 414 may include a plurality of training sets. The vehicle image data 414 may include images acquired from a camera with a constrained camera pose, meaning, the images are acquired with the same camera pose and an unconstrained camera pose, meaning, the images are acquired with different camera poses.

In some embodiments, the non-transitory memory 406 may include components disposed at two or more devices, which may be remotely located and/or configured for coordinated processing. In some embodiments, one or more aspects of the non-transitory memory 406 may include remotely-accessible networked storage devices configured in a cloud computing configuration.

User input device 432 may comprise one or more of a touchscreen, a keyboard, a mouse, a trackpad, a motion sensing camera, or other device configured to enable a user to interact with and manipulate data within a camera calibration system 402. In one example, user input device 432 may enable a user to make a selection of a vehicle image to use in training the DL calibration model.

Display device 434 may include one or more display devices utilizing virtually any type of technology. In some embodiments, display device 434 may comprise a computer monitor. Display device 434 may be combined with processor 404, non-transitory memory 406, and/or user input device 432 in a shared enclosure, or may be peripheral display devices and may comprise a monitor, touchscreen, projector, or other display device known in the art, which may enable a user to interact with various data stored in non-transitory memory 406.

It should be understood that camera calibration system 402 shown in FIG. 4 is for illustration, not for limitation. Another appropriate in-cabin camera calibration system may include more, fewer, or different components.

Referring to FIG. 5, an example of an DL calibration model training system 500 is shown, which may be used to train a DL calibration model 524. The DL calibration model 524 may be trained to detect feature points of an input image, and predict descriptions for the detected feature points. Once trained, a trained DL calibration model 530 may be used to estimate extrinsic parameters of an in-cabin camera of a vehicle (e.g., camera 118 of vehicle 100 of FIG. 1) using the feature points, in accordance with one or more operations described in greater detail below in reference to method 900 of FIG. 9. Estimating the extrinsic parameters may also include matching detected 2D feature points of the input image with 3D feature points of a feature point library 538, where the feature point library 538 is generated using the trained DL calibration model 530. DL calibration model training system 500 may be implemented by a camera calibration system, such as camera calibration system 402 of FIG. 4.

The DL calibration model 524 may be stored in a neural network module 518 of the camera calibration system, which may be the same as or similar to the neural network module 408 of the camera calibration system 402 of FIG. 4. The neural network module 518 may include instructions for training, validating, and testing the DL calibration model 524.

The DL calibration model 524 may be trained on a number of training pairs 520 and test pairs 522, where each of training pairs 520 and test pairs 520 may include input data, and target ground truth data. The training pairs 520 and test pairs 522 may be stored in a training module 516 of the camera calibration system, which may be the same as or similar to the training module 410 of camera calibration system 402 of FIG. 4.

In various embodiments, the input data may include one or more pairs of images 504, which may be acquired via a camera 502 of the vehicle (e.g., in-cabin camera 118 or external camera 119 of FIG. 1). For example, the input data may include four pairs, or eight pairs, or 16 pairs of images 504. The images 504 may include images of a reference object placed in a front seat of the vehicle (e.g., seat 104), such as a chessboard. The images 504 may be sorted into at least two sub-datasets, such as constrained camera pose images 508 and unconstrained camera pose images 510. A constrained camera pose refers to a camera mounted at a fixed pose with a specific set of extrinsic parameters (e.g., rotation, R, and translation, t) with reference to a vehicle coordinate system. In other words, a constrained camera pose refers to images captured with the same in-cabin camera and shoot pose. An unconstrained camera pose refers to a camera mounted at any pose with variable sets of extrinsic parameters with reference to the vehicle coordinate system.

Additional image pairs using unconstrained camera poses may be obtained with a homography matrix to enable matching of 2D feature points and descriptions between the image pairs. In particular, the homography matrix may be applied to a first image, such that a second image generated using the homography matrix differs from the first image. The first image and the second image may have the same height and width. Additionally, the second image may differ from the first image with regards to rotation, R, translation, t, and scaling of subjects in the image.

A feature point detection and description process 512 may be performed on both constrained camera pose images 508 and unconstrained camera pose images 510. The feature point detection and description process 512 includes detecting locations of feature points and background points in the constrained camera pose images 508 and unconstrained camera pose images 510. In various embodiments, the feature point detection and description process 512 may be carried out using one or more tools and/or algorithms known in the art. In one embodiment, the scale-invariant feature transform (SIFT) algorithm may be used to perform the feature point detection and description process 512. An output of the feature point detection and description process 512 may be used to assign labels to feature points and non-feature (e.g., background) points. The result may also include encoded descriptions of the feature points and background points, which may be used to label image pairs, as described below in reference to FIG. 7.

The DL calibration model 524 may be trained jointly on two different tasks. The DL calibration model 524 may generate a first output based on a first task, and a second output based on a second task. The first task may be a feature point detection task, where the DL calibration model 524 learns to detect feature points in either or both images of the input image pairs. Specifically, the DL calibration model 524 may output, for each pixel of each image of the input image pairs, a prediction of whether a point at a location of the pixel in a respective image is a feature point or a background point. The feature point is a pixel location with distinctive features (e.g., visual characteristics) such as an edge.

The ground truth data of each training pair 520 for the first, feature point detection task may include, for each pixel of each input image, a label assigned by the feature points detection and description process 512 indicating whether the point at the location of the pixel is a feature point or a background point. For example, the label may include a value of 0 indicating that the point is a feature point, or a value of 1 indicating that the point is a background point. Accordingly, the DL calibration model 524 may output an indication of whether the point at the location of the pixel is a feature point or a background point. In some embodiments, the label may be a single value (e.g., 0 or 1) as described above. In other embodiments, different values, encodings, and/or arrays of values may be used to indicate whether the point is a feature point or a background point.

In at least one embodiment, the output of the DL calibration model 524 may comprise an array with two values, where a first value of the two values is a probability of the point at the location of the pixel being a feature point, and a second value of the two values is a probability of the point at the location of the pixel being a background point. For example, a first array [1,0] may indicate that the point is a feature point, and a second array [0,1] may indicate that the point is a background point. For example, for a point of an input image, the DL calibration model 524 may output a first output array of [0.85, 0.15], which may indicate that the point is predicted to be a feature point with a probability of 85%. Alternatively, the DL calibration model 524 may output a second output array of [0.2, 0.8], which may indicate that the point is predicted to be a background point with a probability of 80%.

Using the two-value array may be advantageous depending on a desired loss function to apply. For example, when a single value output is used, a sigmoid cross-entropy loss function may be used for the detection task. When the two-value array output is used, a softmax negative log likelihood loss function may be used for the detection task.

The second task may be a feature point description task, where the DL calibration model 524 learns to predict a description of a feature point in either or both images of the input image pairs. Specifically, the DL calibration model 524 may output, for each pixel of each image of the input image pairs, an array of values that encode a description of the feature point. The array of values may be a numerical representation of visual characteristics surrounding the feature point that distinguishes one feature point from a different feature point. The feature point description may have various properties, for example, each value of the feature point description may be between −1 and 1; the feature point description may not be human readable; and the feature point description may be normalized, for example, via Euclidean normalization or L2 normalization. For example, each feature point description may be a vector with a length of 256 and a float data type, as shown below:

[−1.43169031e−01 4.58271384e−01 −1.62901267e−01 −9.65002239e−01 −7.17037261e−01 −8.68379533e−01
6.71189949e−02 −5.21657281e−02 2.39461720e−01 −6.16888225e−01 8.75887394e−01 6.35065436e−01
−2.57862490e−02 3.20669636e−03 5.76226473e−01 −3.28777730e−0 −4.57405478e−01 −4.16866779e−01
−2.27968097e−01 −1.42556045e−03 1.73203960e−01 −6.28954291e−01 −2.34341636e−01 4.26671445e−01
1.21125684e−03 5.80443144e−01 −4.99145150e−01 3.49743128e−01 −2.11896852e−01 8.78908753e−01
7.64355540e−01 −5.22589147e−01 2.72085488e−01 5.54731190e−01 3.82850558e−01 2.53446668e−01
3.39921325e−01 −1.68883428e−01 −9.34922993e−01 5.87750636e−01 6.89451158e−01 −1.71338841e−01
5.46122551e−01 7.27262378e−01 6.45273268e−01 3.72664660e−01 2.46289998e−01 −3.18505615e−01
−3.03976774e−01 −1.08477525e−01 4.75602865e−01 −5.36214888e−01 3.86447906e−01 3.87157202e−01
−3.76178890e−01 −7.75162876e−02 −2.44647771e−01 3.88342381e−01 1.23110577e−01 −2.89371341e−01
3.52955461e−01 −1.89600699e−02 −2.12719738e−01 −5.27302861e−01 −8.97994041e−02 1.30612120e−01
−4.66043055e−01 2.15788528e−01 −4.05010879e−01 −1.19115345e−01 3.42263430e−01 4.71167266e−01
−4.28491294e−01 −1.74742043e−01 6.27758741e−01 2.61402637e−01 1.86255246e−01 −2.21359700e−01
−5.95517635e−01 −7.48736933e−02 4.49042469e−01 5.70093215e−01 −2.85882741e−01 −2.86982089e−01
−3.23122501e−01 −1.81990162e−01 9.86513495e−02 −3.35428774e−01 −6.73396215e−02 −7.36446559e−01
9.56638396e−01 1.80800140e−01 −1.02010280e−01 6.29265487e−01 −1.51900202e−01 −1.31430030e−01
2.68870711e−01 −3.88126642e−01 6.13419175e−01 −2.88700238e−02 2.10499957e−01 −3.22122365e−01
1.15255229e−01 −3.04747492e−01 −3.52769971e−01 1.44565836e−01 2.02660516e−01 −4.77666736e−01
−1.01362363e−01 −2.42617667e−01 −6.98205471e−01 −1.29087687e−01 −4.10853803e−01 −2.66897500e−01
−1.26621351e−01 −4.21785444e−01 −4.97935086e−01 1.16082102e−01 −1.44718587e+00 −6.26395047e−01
3.21106195e−01 9.15868729e−02 4.33236808e−01 −2.10027426e−01 1.40686095e−01 −6.03126109e−01
6.59793437e−01 4.38640624e−01 4.29766238e−01 2.13710517e−01 −7.52806887e−02 −4.95135516e−01
−2.87820548e−01 3.89957935e−01 −1.37962446e−01 −7.70931184e−01 −4.24577138e−06 −3.29461172e−02
8.46419483e−03 −4.49042261e−01 −1.46077070e−02 8.03662956e−01 8.05445239e−02 −2.96235561e−01
−8.08543637e−02 −3.30588102e−01 −6.74770027e−02 1.17786482e−01 −2.31662884e−01 9.97441292e−01
−3.27596277e−01 −1.08897902e−01 6.57808125e−01 −7.97800243e−01 −1.03186488e−01 −4.29404408e−01
−4.59218949e−01 2.39089713e−01 1.72060460e−01 7.54326284e−01 6.24122322e−01 1.13830939e−01
1.71436444e−01 1.11234319e+00 3.78195792e−01 2.70797670e−01 2.33033281e−02 −3.58675152e−01
6.89783320e−02 5.64170539e−01 6.52764440e−01 2.42922097e−01 3.54792804e−01 −5.60296834e−01
−9.65531096e−02 7.44043827e−01 1.74399897e−01 −1.97993472e−01 9.34646651e−02 −9.12238598e−01
−1.67903960e−01 −1.70885161e−01 −5.69103718e−01 2.25428969e−01 4.15478855e−01 4.70013827e−01
8.25168788e−01 3.41797695e−02 −1.05919838e+00 2.74597853e−01 6.25017464e−01 4.14869398e−01
6.05404496e−01 4.02130932e−01 −1.20958388e−01 −1.90321550e−01 −8.04612994e−01 −3.17567624e−02
4.70515490e−01 3.50759387e−01 −5.17713241e−02 −3.94614153e−02 −5.01945913e−01 1.71834037e−01
3.44270110e−01 2.13412657e−01 −1.27609670e+00 −4.41648245e−01 −1.57617524e−01 4.22273725e−01
4.70683932e−01 −4.12169518e−03 −7.08442703e−02 2.22695559e−01 4.22131903e−02 1.11095881e+00
−3.19704264e−01 3.50734860e−01 −3.90814453e−01 3.63916457e−02 3.78545493e−01 4.71075058e−01
−8.70998621e−01 −2.62030244e−01 −4.84437734e−01 5.62739134e−01 −8.11361730e−01 −4.22443628e−01
−2.15263188e−01 −2.83228219e−01 7.48567164e−01 1.25580892e−01 −2.23700665e−02 7.06127107e−01
−6.42825484e−01 −3.03269535e−01 −3.00211273e−02 −4.00734067e−01 2.97484547e−01 −1.18004173e−01
6.47764802e−01 −8.27421904e−01 −2.08601549e−01 1.85368642e−01 −1.65401697e−01 1.83179334e−01
7.30600297e−01 −5.28879762e−01 1.06119502e+00 1.02211368e+00 6.10878527e−01 −4.40691859e−01
−4.36311185e−01 −1.21444136e−01 −7.27298930e−02 1.65899292e−01]

Thus, when comparing a first feature point with a second feature point, a Euclidean distance between feature points at a same pixel location may be small, and a Euclidean distance between feature points not at the same pixel location may be large.

For the second, feature point description task, no additional ground truth data may be inputted into the DL calibration model 524. Rather, the DL calibration model 524 may be trained on the feature point description task in an unsupervised manner based on a distance between pairs of feature points and background points in the input image pairs, as described in greater detail below in reference to FIG. 9.

The DL calibration model training system 500 may include a dataset generator, which may generate the training pairs 520 and the test pairs 522 from the labeled images resulting from the feature points detection and description process 512. In various embodiments, the input images and corresponding labels may be combined into a 3D data array of a height H, a width W, and a depth D, where H and W are also dimensions of the constrained camera pose images 508 and unconstrained camera pose images 510. The 3D data array may include one or more pairs of images, and for each image, a corresponding 2D array of ground truth data for each pixel of the images. For example, one 3D data array may have a depth of 4, including a first 2D image at a first layer of the 3D data array; a 2D array of ground truth data for each pixel of the first 2D image at a second layer of the 3D data array; a second 2D image at a third layer of the 3D data array; and a second 2D array of ground truth data for each pixel of the second 2D image at a fourth layer of the 3D data array. The 3D data array may be assigned by the dataset generator as a training pair 520, or as a test pair 522. The test pairs 522 may be used to assess a performance of the DL calibration model 524. Additionally, a number of training pairs 520 may be assigned to a validation set, to ensure that sufficient training data is available to prevent overfitting, whereby the DL calibration model 524 learns to map features specific to samples of the training set that are not present in the test set.

In an embodiment, the 3D data array may be assigned to either the training pairs 520 or the test pairs 522 randomly in a pre-established proportion. For example, the 3D data array may be assigned to either the training pairs 520 or the test pairs 522 randomly such that 90% of the 3D data arrays generated are assigned to the training pairs 520, and 10% of the 3D data array generated are assigned to the test pairs 522. Alternatively, the 3D data array may be assigned to either the training pairs 520 or the test pairs 522 randomly such that 85% of the 3D data array generated are assigned to the training pairs 520, and 15% of the 3D data array generated are assigned to the test pairs 522. It should be appreciated that the examples provided herein are for illustrative purposes, and 3D data arrays may be assigned to the training pairs 520 dataset or the test pairs 522 dataset via a different procedure and/or in a different proportion without departing from the scope of this disclosure.

DL calibration model training system 500 may include a validator 520 that validates the performance of the DL calibration model 524 against the test pairs 522. The validator 526 may take as input a trained or partially trained DL calibration model 524 and a dataset of test pairs 522, and may output an assessment of the performance of the trained or partially trained DL calibration model 524 on the dataset of test pairs 522.

Once the DL calibration model 524 has been validated, the trained DL calibration model 530 may be used to generate the feature point library 538. The trained DL calibration model 530 may be stored in an inference module 518 of the camera calibration system, which may be the same as or similar to the inference module 412 of the camera calibration system 402 of FIG. 4. The inference module 528 may include instructions for deploying the trained DL calibration model 530 to detect one or more feature points and predict their corresponding descriptions from one or more new images 504 generated by camera 502.

A feature point library 538 may be built using a triangulator 536 based on results from a feature matcher 536 and a camera pose estimator 532. The trained DL calibration model 530 may detect the one or more feature points and corresponding descriptions from images 504 that are corrected for camera distortion using a distortion corrector 506. The one or more feature points and corresponding descriptions may be used by the feature matcher 536 to identify feature point pairs. Corrected images 504 may be used by the camera pose estimator 532 to determine a camera pose for each corrected image.

Turning to FIG. 6, an architecture diagram of a convolutional neural network (CNN) 600 is shown, according to an embodiment. CNN 600 may be used to estimate extrinsic parameters of an in-cabin camera as part of an extrinsic calibration procedure, as described in greater detail in reference to FIG. 7. CNN 600 may be trained in an extrinsic DL calibration network training system, such as training system 500 described in reference to FIG. 5. In particular, CNN 600 may be a non-limiting example of DL calibration model 524.

CNN 600 may have an encoder/decoder architecture, including an encoding portion 604 and a decoding portion 606. The encoding portion 604 includes an encoder 604a. The decoding portion 606 includes a first decoder 606a and a second decoder 606b. Each of the encoder 604a, the first decoder 606a, and the second decoder 606b may include a plurality of convolutional layers constituting feature maps, depicted as solid filled rectangles in FIG. 6. In one embodiment, CNN 600 may be implemented using U-NET. The first decoder 606a may be trained to perform a first task, and second decoder 606b may be trained to perform a second task. As described above in reference to FIG. 5, the first task may include detecting feature points in an input image, and the second task may include predicting descriptions of the detected feature points.

CNN 600 includes solid filled rectangles corresponding to feature maps, wherein feature maps comprise a height (top to bottom length as shown in FIG. 6, corresponding to a y spatial dimension in an x-y plane), width (as shown in FIG. 6, assumed equal in magnitude to height, corresponding to an x spatial dimension in an x-y plane), and depth (a left-right length as shown in FIG. 6, corresponding to the number of features within each feature channel).

Starting at input layer 612, an input 602 may be inputted into CNN 600 and mapped to a first set of features. Input 602 may be a three-dimensional (3D) data structure with a width 620, a height 622, and a depth 624. Input 602 may include one or more pairs of 2D input images, where a width of the input image may be equal to width 620 and a height of the input image may be equal to height 622. The depth 624 may depend on a number of pairs of images included in input 602. For example, if one pair of images is included in input 602, input 602 may have a depth of 2 (e.g., storing 2 images). At a first layer of depth 624, a grayscale pixel intensity value may be included for each pixel of a first image. At a second layer of depth 624, a grayscale pixel intensity value may be included for each pixel of a second image. In other examples, additional pairs of images may also be included in input 602, and/or red/green/blue (RGB) pixel intensity values may be used, which may increase the depth 624. For example, if two image pairs are included in input 602, and RGB pixel intensity values are included for each image, depth 624 may be 12 (e.g., four images times three color values for each image). Each pixel intensity value of each may be inputted into a single neuron of input layer 612.

CNN 600 includes a series of mappings, from input 602 received by input layer 612, through the plurality of feature maps, and finally to a first output layer 614 of first decoder 606a and a second output layer 616 of second decoder 606b. A first output 608 may be generated at first output layer 614, and a second output 610 may be generated at second output layer 616.

Each feature map may receive input from a previous feature map, and may transform/map the received input to an output to produce a next feature map. Each feature map may comprise a plurality of neurons, where in some embodiments, each neuron may receive input from a subset of neurons of a previous layer/feature map, and may compute a single output based on the received inputs, wherein the output may be propagated to a subset of the neurons in a next layer/feature map. A feature map may be described using spatial dimensions, such as length and width (which may correspond to features of each pixel of the input image) wherein the dimensions refer to the number of neurons comprising the feature map (e.g., the number of neurons along a length and the number of neurons along a width of a specified feature map).

In some embodiments, the neurons of the feature maps may compute an output by performing a dot product of received inputs using a set of learned weights (each set of learned weights may herein be referred to as a filter), wherein each received input has a unique corresponding learned weight, wherein the learned weight was learned during training of the CNN.

First output 608 may be a 3D data structure with a width 630, a height 632, and a depth 634. Width 630 and height 632 may be equal to width 620 and height 622 (e.g., the width and height of the input image), respectively. Depth 634 may include a number of layers, depending on a number of image pairs included in input 602. For example, if one pair of images is included in input 602, a first layer of output 608 may include, for each pixel of the first input image, a first value indicating whether a location of the pixel is a feature point; a second layer of output 608 may include, for each pixel of the first input image, a second value indicating whether the location of the pixel of the first input image is a background point; a third layer of output 608 may include, for each pixel of the second input image, a third value indicating whether a location of the pixel is a feature point; and a fourth layer of output 608 may include, for each pixel of the second input image, a fourth value indicating whether the location of the pixel is a background point. Thus, via first output 608, CNN 600 may classify points (pixel locations) of various input images (e.g., pairs of input images) as being either feature points or background points.

Second output 610 may be a 3D data structure with a width 640, a height 642, and a depth 644. Width 640 may be equal to width 620 and width 630, and height 642 may be equal to height 622 and height 632 (e.g., the width and height of the input image). Depth 644 may correspond to an array of values, where the array of values may be an encoded description of the point (e.g., feature point or background point) at the location of the corresponding pixel. Thus, via second output 610, CNN 600 may output a predicted description of each feature point or background point detected by first decoder 606a. CNN 600 illustrates feature map transformations that occur as the input image is propagated through the neuron layers of the convolutional neural network, to output the point classifications and predicted descriptions.

The weights (and biases) of the convolutional layers in CNN 600 are learned during training, as will be discussed in more detail with reference to FIG. 9 below. A difference between an output of CNN 600 and target outputs (e.g., the ground truth data included in a corresponding training pair) may be back-propagated through the layers of CNN 600 to update the weights (and biases) of the convolutional layers. In other words, the weights in the convolutional layers of first decoder 606a may be adjusted based on a difference between output 608 and the ground truth classification provided in input 602, in accordance with a first loss function. The weights in the convolutional layers of second decoder 606b may be adjusted based on a difference between descriptions of pairs of points selected from image pairs of input 602, in accordance with a second loss function. CNN 600 may be trained on a plurality of training pairs of data.

It will be appreciated that the current disclosure encompasses neural network architectures comprising one or more regularization layers, including batch normalization layers, dropout layers, Gaussian noise layers, and other regularization layers known in the art of machine learning which may be used during training to mitigate overfitting and increase training efficiency while reducing training duration. Regularization layers are used during CNN training and deactivated or removed during post training implementation of the CNN. These layers may be interspersed between the layers/feature maps shown in FIG. 6, or may replace one or more of the shown layers/feature maps.

It should be understood that the architecture and configuration of CNN 600 shown in FIG. 6 is for illustration, not for limitation, and other appropriate neural networks may be used to estimate extrinsic parameters of an in-cabin camera without departing from the scope of this disclosure.

Referring now to FIG. 7, a method 700 is shown for performing an extrinsic calibration of an in-cabin camera of a vehicle, such as camera 118 of FIG. 1. Extrinsic calibration of the in-cabin camera may include a first stage where a DL calibration model is trained to estimate extrinsic parameters of the in-cabin camera. The first stage may be the first stage 302 of FIG. 3. Extrinsic calibration of the in-cabin camera may further include a second stage, where the trained DL calibration model is used to perform the extrinsic calibration at the vehicle during operation of the vehicle. The second stage may be the second stage 304 of FIG. 3. The first stage of the method 700 may be implemented using the DL calibration model training system 500 of FIG. 5 and/or the camera calibration system 402 of FIG. 4. The second stage of method 700 may be implemented using the computing system 202 of FIG. 2.

One or more operations of method 700 pertaining to the first stage may be stored in non-transitory memory and executed by a processor, such as non-transitory memory 406 and processor 404 of the camera calibration system 402, respectively. One or more operations of method 700 pertaining to the second stage may be stored in non-transitory memory 206 and executed by a processor 204 of computing system 202 of FIG. 2. At an end of the first stage, the trained DL calibration model may be deployed within an DMS or OMS of an ADAS (e.g., DMS 222 or OMS 232 of ADAS 212 of FIG. 2) for the second stage to be carried out.

At 702, the method 700 includes receiving a plurality of images acquired via an in-cabin camera. The plurality of images may include images acquired from a same, constrained or fixed camera pose, referred to herein as constrained images, and/or images acquired from various, unconstrained camera poses, referred to herein as unconstrained images. A constrained camera pose refers to a camera mounted at a fixed pose with a specific set of extrinsic parameters (e.g., rotation, R, and translation, t) with reference to a vehicle coordinate system. In other words, a constrained camera pose refers to images captured with the same in-cabin camera and shoot pose. An unconstrained camera pose refers to a camera mounted at any pose with variable sets of extrinsic parameters with reference to the vehicle coordinate system. The in-cabin camera may acquire a plurality of images of an in-cabin environment. Additionally, in some embodiments, the plurality of images may include images from an external camera of the vehicle, which may include more abundant information than the in-cabin camera, which may increase a representative ability of the DL calibration model. The external camera, which may be the camera 119 of FIG. 1, may acquire a plurality of images of an environment external to the vehicle.

At 704, the method 700 includes creating a dataset D_{model} with the images from the constrained and unconstrained camera poses of the in-cabin camera and external camera. D_{model} may be used to generate training data for training the DL calibration model. The dataset D_{model} may comprise a plurality of sub-datasets including data collected with constrained camera poses and data collected with unconstrained camera poses from any environment. For example, a first sub-dataset may include images acquired with various constrained camera poses. The first sub-dataset may include additional datasets acquired with a same constrained camera pose. A second sub-dataset may include images acquired with unconstrained camera poses. The second sub-data set may include additional datasets acquired with particular unconstrained camera poses and images generated by applying a homography matrix to an image with a particular unconstrained camera pose, as described below in reference to FIG. 7.

In one embodiment, a specifically designed reference object may be placed in the interior of a vehicle. The specifically designed reference object may be an object that has a highly structured geometry. In various embodiments, a chessboard may be used, where the chessboard may be placed in a driver seat or a passenger seat (e.g., within a field of view of the camera). The in-cabin camera may acquire images of the chessboard at constrained camera poses or unconstrained camera poses. One advantage of using a chessboard is that existing tools and/or algorithms for detecting feature points of a chessboard may be leveraged during labeling of training samples, as described in greater detail below.

Images acquired with the same constrained camera pose may include the same captured content and objects. However, coloration, brightness, and contrast may differ in images acquired with the same constrained camera pose. For example, images acquired at different times during the day with an in-cabin camera mounted with a constrained camera pose may exhibit different brightness characteristics due to the position of the sun.

At 706, the method 700 includes creating a second dataset D_{library} with images from unconstrained camera poses. Images included in D_{library} may be used to train the DL calibration model and build a feature point library, described in greater detail below in reference to FIG. 10. Each image may be captured with a different camera pose (e.g., rotation, R, and translation, t), so that triangulation may be applied during building of the feature library. By acquiring images with different camera poses, pixel locations with distinct visual characteristics in a first image may be matched with the same pixel locations in a second image, even if the images were acquired with different cameras or different poses.

Dataset D_{library} may include images of a reference object placed in the cabin. In various embodiments, the reference object is a chessboard. The chessboard may be used as a reference to accurately estimate a camera pose and a scaling factor between pixels of an image and the real world. By acquiring images with chessboards, pixel locations with distinct characteristics in one image may be matched with the same pixel locations in another image, regardless of scaling differences between the two images.

At 708, the method 700 includes extracting feature points of each image in D_{model} and D_{library} using a feature point detector. In some embodiments, the feature point detector may be part of camera calibration system 402 of FIG. 4. In other embodiments, the feature point detector may be a separate system independent from camera calibration system 402. In one embodiment, feature point detection is performed by the scale-invariant feature transform (SIFT) algorithm. The feature point detector may take an image as input, and output, for each pixel location of the image, a probability that the pixel location is a feature point. The feature point detector may also output a description for each pixel location. The descriptions may contain information regarding visual characteristics surrounding the feature point. The feature point detector may detect the same feature points in different images of the reference object, regardless of whether the images are acquired with constrained or unconstrained camera poses and whether the coordinates of the same feature points vary from image to image.

Referring briefly to FIG. 13, an image 1300 is shown, indicating a plurality of feature points detected in an image of a cabin of a vehicle by a feature point detector, where the feature points are indicated as circles (e.g., such as a first feature point 1302 and a second feature point 1304). In the embodiment depicted in FIG. 13, the feature points were detected using the SIFT algorithm. As shown, the SIFT algorithm extracts feature points from both portions of the cabin and the chessboard. However, the efficiency and/or accuracy of the SIFT algorithm may be higher for the chessboard than the portions of the cabin due to high contrast edges of the chessboard. All other points in image 1300 not identified by circles may be considered background points.

Returning to method 700, at 710, the method 700 includes extracting feature points of each image in D_{library} using a chessboard detection algorithm. The chessboard detection algorithm may be an alternative feature point detector, which may extract 2D feature points of each image in D_{library}. In particular, pixel positions of corner points may be detected using the chessboard algorithm.

At 712, the method 700 includes generating a first set of positive (e.g., feature point) and negative (e.g., background) labels for each pixel location of each image in D_{model} for training the DL calibration model on a feature point detection task. The feature point detection task includes performing a binary classification of each pixel location in an image as a feature point or a background point, using the labeled images as ground truth data. For the purposes of this disclosure, a positive label is a first assigned value (e.g., 0) that indicates that a feature point is included at the pixel location, and a negative label is a second assigned value (e.g., 1) that indicates that a background point is included at the pixel location. The positive and negative labels may be generated using either or both of the feature point detector and chessboard detection algorithm.

In one embodiment, the feature point detector may output, for each pixel location, a probability that the pixel location is a feature point. A positive label may be assigned to pixel locations of the image having a probability of being a feature point above a threshold probability. Negative labels may be assigned to pixel locations having a probability of being a feature point below the threshold probability. In other words, positive labels may be generated from a set of all pixel locations, and the remaining pixel locations may be assigned the negative label. In some embodiments, points on a boundary between a feature point and a background point may be further filtered.

At 714, the method 700 includes generating a second set of positive and negative labels for pairs of images of D_{model} for training the DL calibration model on a pixel location description task. The pixel location description task includes predicting a robust, low-dimension description for each feature point and background point. The description includes an n-length vector with float or integer values. Instructions stored in the DL calibration model system and executed by a processor may generate pairs of images, and may generate the positive and negative labels for points of the pairs of images according to the method of FIG. 8.

At 716, the method 700 includes training neural network jointly on detection task and description task with training pairs from D_{model}. The training pairs may be generated as described above in reference to FIG. 5, where each training pair includes at least one pair of images and corresponding ground truth information for each image of the pair of images. For constrained images, any two constrained images may be paired as an image pair. For unconstrained images, a homography matrix may be applied to a first image acquired with an unconstrained camera pose to randomly generate a second unconstrained image, where a mapping of the homography matrix may allow points of the second unconstrained image to be associated with corresponding points of the first unconstrained image. In this way, the second unconstrained image may have the same content and objects as the first unconstrained image, but may differ from the first unconstrained image with regards to rotation and scaling. In some examples, a random color transformation may also be performed to generate the second unconstrained image. The unconstrained image pairs may be generated randomly in real time during training of the DL calibration model. Joint training of the DL calibration model is described in greater detail below in reference to FIG. 9.

At 718, the method 700 includes using a trained neural network to build a feature point library using the images from D_{library}. Building the feature point library is described in greater detail below in reference to FIG. 10.

At 720, the method 700 includes using the feature point library to perform online extrinsic calibration of a camera. Performing the online extrinsic calibration is described in greater detail below in reference to FIG. 11. Method 700 ends.

FIG. 8 shows a method 800 for generating pairs of images with pairs of feature points and/or background points for the description task, where the pairs of feature points have positive and negative labels. Method 800 may be implemented as part of the DL calibration model training system 500 of FIG. 5. In an embodiment, one or more operations of method 800 may be stored in non-transitory memory and executed by a processor, non-transitory memory 406 and processor 404 of a camera calibration system 402 of FIG. 4.

At 802, the method 800 includes generating pairs of constrained images with positive pairs of feature points for the datasets D_{model} and D_{library}. For two different constrained images, real world objects will be referenced at a same pixel location. As a result, any two constrained images may be paired as an image pair. In various embodiments, constrained images with different environmental settings may be selected as image pairs. For example, a first constrained image of an image pair may show a reference object in the real world (e.g., a chessboard) with a first lighting, and a second constrained image of the image pair may show the reference object with a second lighting. A feature point detector (e.g., SIFT) may be unable to recognize the same feature point pairs of the chessboard in the same image with different lighting. By generating pairs with different lighting, a trained DL calibration model may be able to recognize the same feature point pairs regardless of difference in lighting in pairs of images.

Positive pairs of feature points are feature points of different images (e.g., of an image pair) that correspond to a same reference position in the real world. For example, a first image of an image pair may include a chessboard placed in a driver's seat of a vehicle, and a second image of the image pair may also include the chessboard. A corner of the chessboard may be a feature point in both the first image and the second image. Therefore, the feature point corresponding to the corner of the chessboard of the first image and the feature point corresponding to the corner of the chessboard of the second image may be a positive pair of feature points. For images in D_{model} acquired with the constrained camera pose, feature points located at the same pixel location of two images may be applied as positive pairs. For images in D_{library}, all feature points located on the chessboard may also be applied as positive pairs.

At 804, the method 800 includes generating positive pairs of feature points in constrained and unconstrained images using data augmentation. The data augmentation may be particularly relevant to unconstrained images. Since the unconstrained images do not share a camera pose, real world reference points may appear at different pixel locations in different unconstrained images. Therefore, positive pairs of feature points may not be established between two unconstrained images. To generate positive pairs of feature points using data augmentation, an image pair is created mathematically from a single unconstrained image, where a first set of feature points of an original unconstrained image corresponding to reference positions in the real world may be mapped to a second set of feature points of a mathematically generated unconstrained image corresponding to the same reference positions. To generate the mapping, the original image may be transformed with a random homography matrix. Feature points of the original image and transformed image may then be applied as positive pairs.

At 806, the method 800 includes generating negative pairs of points in pairs of images in D_{library} and D_{model}, where negative pairs of points are pairings of points in the images that do not refer to a same reference position in the real world. For example, a feature point of a first image of an image pair and a background point of a second image of the image pair may be labeled a negative pair (e.g., where the feature point and the background point are detected by a feature point detector, for example, using SIFT). Alternatively, a distance metric may be calculated between SIFT descriptions of different points of the images in D_{library} and D_{model}, and two feature points having descriptions that exceed a pre-determined distance threshold may be a negative pair.

As an example of how the positive and negative labels are generated, for each iteration, the DL calibration model may be trained on n pairs of images. For each pair of images with the same constrained camera pose, the feature points of the first image and the feature points of the second image are extracted and collected. The feature points from the first image and the second image may be concatenated, forming a total number of feature points.

To generate pairs of images with an unconstrained camera pose, a second image may be generated from the first image by applying a homography matrix to the first image after the feature points are extracted and collected. The second image may adjust a rotation, translation, and/or scaling of the first image. The locations of feature points of the first image are projected onto the second image generated by the homography matrix. The feature points of the second image located at a boundary of the second image may be filtered. The same feature points located at the image boundary in the first image are filtered as well.

After filtering the feature points at the image boundary, the background points of the first image and the background points of the second image may be extracted and collected. A random sampling of the background points of both the first image and second image may be performed. In one embodiment, the ratio of background points to feature points may be a floating number that is less than or equal to two. The feature points of the second image are projected onto the first image by applying an inverse homography matrix.

In this way, the training labels are generated for pairs of images acquired with constrained camera poses and unconstrained camera poses. The input images may be transformed in color space, using operations such as “blur,” “random contrast,” and “random brightness” and input into the DL calibration model during training. Applying these transformations to the images do not change the locations of feature points.

During training, the locations of feature points in the first image are predicted as a first output and a first set of descriptions are predicted by the DL calibration model as a second output. The first set of descriptions may be considered anchor data. The locations of feature points in the second image are also predicted in the first output and a second set of descriptions are predicted by the DL calibration model in the second output. Descriptions from the second set of descriptions may be associated with corresponding descriptions of the first set of descriptions as positive pairs. Locations of background points in the first image and locations of feature points with descriptions outside a threshold distance of the anchor data may be randomly sampled and assigned as negative pairs.

Referring to FIG. 9, a flow chart of a method 900 for training a DL calibration model (such as the DL calibration model 524 of the extrinsic DL calibration training system 500 of FIG. 5) is shown, according to an exemplary embodiment. The DL calibration model may be a deep neural network with a plurality of convolutional layers, such as the CNN 600 of FIG. 6. Method 900 may be implemented as part of the extrinsic DL calibration training system 500. One or more operations of method 900 may be stored in non-transitory memory and executed by a processor of a camera calibration system, such as the non-transitory memory 406 and processor 404 of camera calibration system 402 of FIG. 4.

Method 900 begins at 902, where method 900 includes receiving a training pair from a training dataset, such as training pairs 520 described above in reference to FIG. 5. Each training pair may comprise one or more image pairs and corresponding ground truth data. In an embodiment, the training set may be stored in a training module of the camera calibration system, such as the training module 410.

At 904, method 900 includes inputting input images (e.g., pixel intensity values of each image of one or more image pairs) of the training pair into an input layer of the DL calibration model. Each pixel intensity value of the input image may input into a distinct neuron of the input layer of the DL calibration model.

At 906, method 900 includes receiving an output of the DL calibration model. Image data of the input images is propagated through the DL calibration model from the input layer, through one or more convolutional layers, until reaching a first output layer corresponding to a detection task of the DL calibration model, and a second output layer corresponding to a description task of the DL calibration model. As described above, a first output of the first output layer corresponding to the detection task may be may be a first 3D data structure with a width, a height, and a depth. The width and height of the first 3D structure of the detection task may be equal to a width and height of the input images, respectively. The depth of the first 3D structure of the detection task may include a number of layers, depending on a number of image pairs included in the input of the DL calibration model.

A second output of the second output layer corresponding to the description task may be a second 3D data structure with a width, a height, and a depth. The width and height of the second 3D structure may be equal to the width and height of the input images, respectively. The depth of the second 3D structure may correspond to an array of values, where the array of values may be a predicted description of the point (e.g., feature point or background point) at a corresponding pixel location.

At 908, method 900 includes determining and back propagating a first loss, based on a difference between the first output of the DL calibration model and the ground truth data of the training image pair, through a plurality of convolutional layers of a detection task portion of the DL calibration model (e.g., first decoder 606a of FIG. 6). The first loss may be back propagated in accordance with a first loss function. For example, the first loss function may be a softmax negative log likelihood loss function.

$${ℒ}_{det} = - {\sum }_{i}^{c} {y}_{i} log {z}_{i} \qquad ( 1 )$$

where i is the current category of a point (e.g., feature point, background point), and the value can be 1 or 2; C is the number of all categories of points, in this case, 2; zᵢ is a probability of the point being of the current category; and yᵢ is the ground-truth probability of the point being of the current category (e.g., supervised information generated using the SIFT algorithm). In other embodiments, a different loss function may be used. For example, the first loss function may be a sigmoid cross-entropy loss function.

Back propagation of the loss may occur according to a gradient descent algorithm, wherein a gradient of the loss function (a first derivative, or approximation of the first derivative) is determined for each weight and bias of the DL calibration model. Each weight (and bias) of the DL calibration model is then updated by adding the negative of the product of the gradient determined (or approximated) for the weight (or bias) with a predetermined step size.

At 910, method 900 includes determining and back propagating a second loss through a plurality of convolutional layers of a description task portion of the DL calibration model (e.g., second decoder 606b of FIG. 6). The second loss may be back propagated in accordance with a second loss function. The second loss may not be based on ground truth data inputted into the DL calibration model. For example, the second loss function may be a triplet loss function, as described below:

$${ℒ}_{d e s} = - max ( d ( a , p ) - d ( a , n ) + margin , 0 ) \qquad ( 2 )$$

where
a is anchor data, a description of a first feature point (a vector with float data type);
p is positive data, a description of a second feature point;
n is negative data, a description of a background point;
margin is a pre-defined constant that is greater than 0; and
d is distance, meaning Euclidean distance.

The triplet loss function may calculate a distance between the positive pairs of points and the negative pairs of points, which may then be pushed/pulled based on the loss values. In other words, the distance between positive pairs of points (e.g., two feature points of two images referencing a same point in the real world) will be minimized, and the distance between the negative pairs (e.g., a feature point and a background point of an image or pair of images) will be maximized. As a result, the weights and biases of the DL calibration model may converge on values that output accurate predicted descriptions generated for each pixel location of each input image. Put another way, during the training, the description loss forces the descriptions of all points to change to attempt to reach an equilibrium, where positive pairs are separated by small distances and negative pairs are separated by greater distances. It should be appreciated that in some cases, the descriptions may change in a manner that does not converge, resulting in a training failure.

At 912, method 900 includes calculating and back propagating a final loss [symbol] _{f} through a shared portion of the DL calibration model (e.g., encoder 604a), and adjusting weights and biases of the shared portion of the DL calibration model. The final loss [symbol] may be the sum of the loss for the detection task (e.g., the cross-entropy loss) and the triplet loss for the description task, based on both the first and second outputs, as described below:

$${ℒ}_{f} = {ℒ}_{det} + λ {ℒ}_{d e s} \qquad ( 3 )$$

where λ is a balancing factor for the two tasks (e.g., the detection task and the description task).

Method 900 may then end. It will be noted that method 900 may be repeated until the weights and biases of the DL calibration model converge, or the rate of change of the weights and/or biases of the deep neural network for each iteration of method 900 are under a threshold.

While not described in method 900, it should be appreciated that in order to avoid overfitting, training of the DL calibration model may be periodically interrupted to validate a performance of the DL calibration model on a set of test pairs (e.g., test pairs 522). The test pairs may be generated as described in method 500 of FIG. 5, and may be taken at random from a larger training data set. In an embodiment, training of the DL calibration model may end when the performance of the DL calibration model on the test pairs converges (e.g., when an error rate on the test set converges on a minimum value).

FIG. 10 shows a flow chart of a method 1000 for deploying a trained DL calibration model (such as the trained DL calibration model 530 of FIG. 5 and/or the CNN 600 of FIG. 6) for building a feature point library, according to an exemplary embodiment. In various embodiments, the feature point library may be a reference or lookup table stored in a memory of a camera calibration system, such as the non-transitory memory 406 of the camera calibration system 402 of FIG. 4. The feature point library may include a plurality of 2D feature points and descriptions generated using the trained DL calibration model. In an embodiment, one or more operations of method 1000 may be stored in non-transitory memory and executed by a processor of the camera calibration system, such as processor 404. The trained DL calibration model may be stored in an inference module (e.g., inference module 412) of the camera calibration system. The feature point library resulting from method 1000 may be deployed in a vehicle, where it may be used for an online extrinsic calibration of a camera of the vehicle (e.g., camera 118 and/or camera 119), as described below in reference to FIGS. 11 and 12.

At 1002, the method 1000 includes correcting for camera distortion in images in dataset D_{library}. Camera distortion may include radial distortion and tangential distortion. Radial distortion may be caused by imperfections in curvature of a camera lens. Tangential distortion may be caused by the camera lens and image plane not being parallel during acquisition of the image. Camera distortion may be corrected using a camera's intrinsic matrix comprising an intrinsic matrix K_{raw} with calibrated intrinsic camera parameters, such as focal length, the optical center, and the skew coefficient, and distortion coefficients d_{raw}. The calibrated intrinsic camera parameters may be determined by a manufacturer or pre-intrinsic calibration of the camera. In this way, a new image without distortion may be generated from a raw image with distortion.

In particular, to correct for the distortion, the new image is generated using a new intrinsic matrix with calibrated intrinsic camera parameters and no distortion coefficients. Each pixel of the new image, described by the following equation (4):

$${\tilde{p}}_{n e w}^{2 d} = {[ {x}_{n e w} , {y}_{n e w} , 1 ]}^{T} ) \qquad ( 4 )$$

may be matched to a corresponding pixel in the raw image, which may be described by the following equation (5):

$$( e . g . , {\tilde{p}}_{r a w}^{2 d} = {[ {x}_{raw} , {y}_{r a w} , 1 ]}^{T} ) \qquad ( 5 )$$

Each point of the new image coordinate system of the camera is converted to a sensor coordinate system of the camera, according to the following equation:

$${\tilde{p}}_{c a m e r a}^{2 d} / {\tilde{p}}_{u n - distorted}^{2 d} = {K}_{new}^{- 1} * {\tilde{p}}_{n e w}^{2 d} = {[ {x}_{new} , {y}_{n e w} , 1 ]}^{T} \qquad ( 6 )$$

where

$${\tilde{P}}_{c a m e r a}^{2 d}$$

is a undistorted 2D camera pixel,

$${\tilde{p}}_{un - distorted}^{2 d}$$

is a undistorted 2D camera pixel, K_{new}⁻¹ is the new intrinsic matrix, and

$${\tilde{p}}_{n e w}^{2 d}$$

is a new 2D camera pixel. A distortion model and distortion coefficients d_{raw} are used to calculate the 2D distorted pixel,

$${\tilde{p}}_{distorted}^{2 d} .$$

Each point of the sensor coordinate system may then be converted to a raw image coordinate system of the camera, using the following equation:

$${\tilde{p}}_{r a w}^{2 d} = {K}_{r a w} * {\tilde{p}}_{distorted}^{2 d} \qquad ( 7 )$$

where

$${\tilde{p}}_{r a w}^{2 d}$$

is a 2D raw image pixel, K_{raw} is the raw intrinsic matrix, and

$${\tilde{p}}_{distorted}^{2 d}$$

is a 2D distorted pixel. Using a one-to-one pixel relation, the un-distorted camera image may be generated.

At 1004, the method 1000 includes detecting 2D feature points of images in D_{library} and predicting corresponding descriptions for the pixels of the images using the trained DL calibration model. Images from D_{library} may be inputted into the trained DL calibration model, and the DL calibration model may output, for each pixel, a first probability that the pixel includes a feature point, and a second probability that the pixel includes a background point, as a first output (e.g., via decoder 606a of CNN 600). Thus, the feature points of each image may be detected by the trained DL calibration model. The DL calibration model may also output corresponding descriptions for each of the detected 2D feature points, as a second output (e.g., via decoder 606b of CNN 600).

At 1006, the method 1000 includes determining a relative camera pose between each image of a pair of images. In one embodiment, a chessboard detection algorithm may be used to detect corner points of a chessboard included in the images of D_{library}. A camera pose between the camera and the chessboard is estimated for each image, based on the detected corner points of the chessboard. Since a physical size of the chessboard is known, a real-world scaling of an image may be determined. The detected corner points of the chessboard in two images may be used to determine the relative camera pose between the two images.

Referring briefly to FIG. 14, an exemplary chessboard 1400 is shown on a 3D (e.g., x/y/z) coordinate system, where a length of the side of any square on chessboard 1400 is L. The 3D coordinates

$${\tilde{p}}_{c b}^{3 d}$$

of points on chessboard 1400 can be directly calculated and are indicated in terms of L.

Based on the chessboard detection algorithm, the 2D coordinates

$${\tilde{p}}_{cb \_ image \_ 1}^{2 d}$$

of points of chessboard on an image can be detected. The 2D coordinates may be converted to coordinate system of a camera (e.g., camera 118 of FIG. 1) using the following equation:

$${\tilde{p}}_{cb \_ camera \_ 1}^{2 d} = {K}_{new}^{- 1} * {\tilde{p}}_{cb \_ image \_ 1}^{2 d} \qquad ( 8 )$$

Pose estimation (PnP) for this image with respect to the chessboard coordinate system R_{cb_1}, t_{cb_1} can be achieved as follows:

$${\tilde{p}}_{cb \_ camera \_ 1}^{2 d} = {R}_{cb \_ 1} * {\tilde{p}}_{c b}^{3 d} + {t}_{cb \_ 1} \qquad ( 9 )$$

$${R}_{cb \_ 1}^{- 1} * ( {\tilde{p}}_{cb \_ camera \_ 1}^{2 d} - {t}_{cb \_ 1} ) = {\tilde{p}}_{c b}^{3 d} \qquad ( 10 )$$

Similar to the above steps, given a new image, the R_{cb_2}, t_{cb_2} can also be achieved using equations 11, 12, and 13 below:

$${\tilde{p}}_{cb \_ camera \_ 2}^{2 d} = {R}_{cb \_ 2} * {\tilde{p}}_{c b}^{3 d} + {t}_{cb \_ 2} \qquad ( 11 )$$

$${\tilde{p}}_{cb \_ camera \_ 2}^{2 d} = {R}_{cb \_ 2} * {R}_{cb \_ 1}^{- 1} ( {\tilde{p}}_{cb \_ camera \_ 1}^{2 d} - {t}_{c {b}_{1}} ) + {t}_{cb \_ 2} \qquad ( 12 )$$

$${\tilde{p}}_{cb \_ camera \_ 2}^{2 d} = {R}_{cb \_ 2} * {R}_{cb \_ 1}^{- 1} * {\tilde{p}}_{cb \_ camera \_ 1}^{2 d} + {t}_{cb \_ 2} - {R}_{cb \_ 1}^{- 1} * {t}_{cb \_ 1} \qquad ( 13 )$$

Consequently, the relative camera pose is given by equation 14:

$${R}_{cb \_ 2} * {R}_{cb \_ 1}^{- 1} and {t}_{cb \_ 2} - {R}_{cb \_ 1}^{- 1} * {t}_{cb \_ 1} \qquad ( 14 )$$

Returning to FIG. 10, at 1008, the method 1000 includes matching 2D feature points and corresponding descriptions for each pair of images. For each pair of images in D_{library}, pairs of feature points are matched based on a similarity of feature point descriptions (e.g., where a distance between the descriptions of the respective feature points is within a distance threshold). The distance may be a Euclidean distance between two vectors of numbers comprising two different descriptions for two matched feature points.

At 1010, the method 1000 includes performing a triangulation of matched feature points for the pairs of images to determine respective 3D feature points and corresponding descriptions. Triangulation is performed with a pair of matched feature points and known camera positions, to determine a 3D feature point that is positioned closest to 3D rays corresponding to the matched 2D feature points observed by the cameras and originating from a camera(s) center in particular directions.

In particular, the triangulation of matched 2D feature points in conjunction with known camera positions may be achieved by projecting 3D points in the world's coordinate system onto a first image using a matrix of the first image and using the first camera pose of the first image as the world coordinate system. Projection of the 3D points in the world's coordinate system may be performed by the following equation:

$$K \times [ R \vert t ] \qquad ( 15 )$$

where K is intrinsic matrix of the camera for the first image (e.g., 3×3 matrix) which includes a set of intrinsic camera parameters, R is a rotation matrix (e.g., 3×3 matrix), and t is a translation vector (e.g., 3×1). When the first camera pose is used as the world coordinate system, equation 15 may be adjusted to:

$$K \times [ \begin{matrix}1 & 0 & 0 & 0 \\ 0 & 1 & 0 & 0 \\ 0 & 0 & 1 & 0\end{matrix} ] \qquad ( 16 )$$

A matrix of the second image may project 3D points in the worlds coordinate system onto the first image using equation 15. When the first camera pose of the first image is used as the world coordinate system, the matrix of the second image, [R|t] (e.g., 3×4 matrix) may be related to the relative camera pose according to the following equation:

$$K \times [ {R}_{relative} \vert {t}_{relative} ] \qquad ( 17 )$$

where K is an intrinsic matrix with intrinsic camera parameters, Rᵣₑₗₐₜᵢᵥₑ is a relative rotational matrix (e.g., 3×3 matrix) and tᵣₑₗₐₜᵢᵥₑ is a relative translational vector (e.g., 3×1).

In this way, equation 17 may be used to match feature points in a second image with feature points in a first image and determine the corresponding 3D points and descriptions based on the first camera coordinate system.

Referring now to FIG. 11, a flowchart is shown of a method 1100 for using a trained DL calibration model (e.g., DL calibration model 530 of FIG. 5) in a computing system of a vehicle, such as computing system 200 of FIG. 2, according to an exemplary embodiment. Method 1100 may be executed by a processor of the computing system, such as the processor 204 of FIG. 2. Operations of method 1100 may be stored in a non-transitory memory of the computing system (e.g., in the image analysis module 210).

At 1102, the method 1100 includes receiving a plurality of images from a camera of the vehicle, which may be the camera 218 in FIG. 2. In some embodiments, the plurality of images may be acquired in real-time or near real-time by a DMS and/or OMS system of the vehicle, which may be DMS 147 and/or OMS 148 of FIG. 1.

At 1104, the method 1100 includes detecting and describing a plurality of feature points in the images, using the trained DL calibration model. The plurality of images received may be inputted into the trained DL calibration model, and the DL calibration model may output the 2D feature points and generate feature point descriptions for the 2D feature points.

At 1106, the method 1100 includes matching the detected 2D feature points from the images with 3D feature points of the feature point library. A 2D feature point of an image may be mapped to a corresponding 3D feature point in the feature point library by matching the description of the 2D feature point of the image with the description of the 3D feature point in the feature point library. In this way, the corresponding 3D feature points of the feature point library may be determined based on the 2D feature points.

At 1108, the method 1100 includes determining a set of extrinsic parameters of the camera based on the mapped 3D feature points. Sets of points with a one-to-one correspondence are established for 2D feature points and 3D feature points. In conjunction with the one-to-one corresponding sets of points in 2D and 3D, the extrinsic parameters of the in-cabin camera may be solved via Perspective-n-Point (PnP) algorithms. Examples of PnP algorithms that may be utilized may include Efficient Perspective-n-Point (EPnP) and Levenberg-Marquardt optimization.

FIG. 12 shows an exemplary method 1200 for determining whether to adjust an operation of a vehicle based on an output of a trained neural network model of an ADAS of the vehicle. In at least one embodiment, the trained neural network model may take as input one or more images of a driver of the vehicle acquired via an in-cabin camera (e.g., in-cabin camera 118 of FIG. 1) of the vehicle, which may be part of a DMS system of the vehicle (e.g., DMS 147). In the depicted embodiment, the trained neural network model may output a probability that a level of alertness of the driver is low enough to warrant an intervention by the ADAS. In other embodiments, the trained neural network model, or a different trained neural network model of the ADAS may predict a different emotional state of the driver. For example, the driver may be anxious, angry, etc. Based on the output, the ADAS may adjust an operation of the vehicle, notify the driver with a sound or message, or perform a different action of the vehicle.

Prior to inputting the one or more images into the trained neural network model, the in-cabin camera may be calibrated. Calibrating the in-cabin camera may increase a performance of the trained neural network model, leading to more timely and accurate ADAS interventions The in-cabin camera may be calibrated using an DL calibration model trained according to the methods described herein. Instructions for carrying out method 1200 may be stored in non-transitory memory and executed by a processor of a vehicle computing system, such as computing system 120 of FIG. 1, and/or an ADAS of the vehicle, such as ADAS 149 of FIG. 1.

Method 1200 begins at 1202, where the method includes estimating and/or measuring vehicle operating conditions. Vehicle operating conditions may be estimated based on one or more outputs of various sensors of the vehicle (e.g., such as oil temperature sensors, engine velocity or wheel velocity sensors, torque sensors, etc.). Vehicle operating conditions may include engine velocity and load, vehicle velocity, transmission oil temperature, exhaust gas flow rate, mass air flow rate, coolant temperature, coolant flow rate, engine oil pressures (e.g., oil gallery pressures), operating modes of one or more intake valves and/or exhaust valves, electric motor velocity, battery charge, engine torque output, vehicle wheel torque, etc. Estimating and/or measuring vehicle operating conditions may include determining whether the vehicle is being powered by an engine or an electric motor.

Estimating and measuring the vehicle operating conditions may also include determining a proximity of other vehicles to the vehicle, in a lane of traffic of the vehicle or in other lanes of traffic, via one or more cameras and/or sensors positioned on or in the vehicle (e.g., camera 128 of FIG. 1). The vehicle operating conditions may include road conditions (e.g., whether the road is paved or unpaved, wet, icy, etc.), weather conditions (e.g., whether it is raining or snowing), and/or other external conditions of the vehicle (e.g., whether it is daytime or night time, etc.).

At 1204, the method includes receiving image data of a driver of the vehicle from the in-cabin camera and/or DMS of the vehicle. For example, the in-cabin camera may capture images of the driver as the driver views an upcoming segment of road, including traffic and/or other vehicles ahead of the vehicle. The DMS may capture images of the driver looking out of one or more side windows of the vehicle and/or glancing at the rear view mirror. The DMS may capture images of the driver interacting with other occupants of the vehicles.

At 1205, the method includes performing an extrinsic calibration of the in-cabin camera, using a trained DL calibration model. During the extrinsic calibration, a set of extrinsic parameters of the camera may be estimated from images acquired via the in-cabin camera, as described above in reference to FIG. 11. The extrinsic calibration may be performed by using the trained DL calibration model to detect 2D feature points and generate corresponding descriptions, performing feature matching between the 2D feature points and description of the image and 2D feature points and descriptions in the library to identify corresponding 3D feature point and descriptions for the image, and determining extrinsic parameters using PnP algorithms based one intrinsic camera parameters, 2D feature points and descriptions, and the 3D feature points and description. The extrinsic parameters of the camera may be used to perform the extrinsic calibration.

At 1206, the method includes processing the image data to determine whether to adjust an operation of the vehicle based on the image data. In the depicted embodiment, the ADAS may adjust the operation of the vehicle in response to a predicted level of alertness of the driver decreasing below a threshold level of alertness.

At 1208, processing the image data to determine whether to adjust the operation of the vehicle includes using the trained neural network to predict the level of alertness of the driver. For example, the level of alertness of the driver may be predicted based on facial expressions of the driver; postural indications of tiredness, such as slouching or head dipping; periods of time with no movement of the driver; detected movement or slipping of eyelids of the driver; and so on. The predicted alertness may be a value between 0.0 and 1.0, where 1.0 indicates a highest level of alertness, and 0.0 indicates a lowest level of alertness.

In other embodiments, the ADAS may adjust the operation of the vehicle in response to a different predicted state of the driver, or an identification of the driver, or different characteristics of the driver's behavior. It may be appreciated that the examples and embodiments described herein are for illustrative purposes, and the trained neural network model may be used by the ADAS or the DMS to adjust the operation of the vehicle in other ways without departing from the scope of this disclosure.

At 1210, the method includes determining whether the predicted level of alertness outputted by the trained neural network model is below a threshold level of alertness. For example, the threshold level of alertness may be 0.5, where if the predicted level of alertness is 0.6, the driver is determined to be above the threshold level of alertness (e.g., alert enough to drive without ADAS intervention). Alternatively, if the predicted level of alertness is 0.4, the driver is determined to be below the threshold level of alertness (e.g., not alert enough to drive without ADAS intervention).

If at 1210 it is determined that the predicted level of alertness outputted by the trained neural network model is not below the threshold level of alertness, the method proceeds to 1212. At 1212, the method includes continuing operation of the vehicle without an intervention of the ADAS system, and the method ends. Alternatively, if at 1210 it is determined that the predicted level of alertness is below the threshold level of alertness, the method proceeds to 1214.

At 1214, the method includes adjusting the operation of the vehicle based on the predicted level of alertness. In other words, the ADAS may perform one or more actions to increase the level of alertness of the driver. For example, the ADAS may notify the driver via an audible sound alerting that the driver appears to be tired, or the ADAS may play an audio file with music or other content that may increase the level of alertness of the driver. In some embodiments, the ADAS may adjust an acceleration or a speed of the vehicle in response to the level of alertness being below the threshold level of alertness, or perform a different action or operation of the vehicle.

By calibrating the in-cabin camera prior to using the trained neural network model to predict the level of alertness of the driver, the ability of the ADAS to determine whether intervention is warranted may be increased. Specifically, the in-cabin camera calibration may increase an accuracy of mathematical relationships between detected feature points in images acquired by the in-cabin camera, which may enable more accurate predictions of driver posture and facial features.

Thus, a camera calibration system of a vehicle is proposed, based on a trained DL calibration model, which may be a CNN. The camera calibration system may be used in conjunction with an ADAS of the vehicle, to increase a performance of the ADAS.

In one example of the advantages provided by implementing the proposed camera calibration system, a first vehicle may include a first ADAS, but may not include the proposed camera calibration system. A controller of the first vehicle may receive images from an in-cabin camera of the first vehicle with varying degrees of lighting, brightness, and/or contrast acquired by a DMS of the first vehicle. The first ADAS may be less accurate in identifying feature points of images of the driver, due to a neural network model of the ADAS not being trained using images with varying degrees of lighting, brightness, and/or contrast. A decrease in accuracy of feature point detection may result in a decreased performance of the neural network model of the ADAS, whereby a level of alertness of a driver of the first vehicle may not be accurately predicted. As a result of the level of alertness of a driver of the first vehicle not being accurately predicted, the ADAS may not intervene in a timely manner to increase the driver's level of alertness.

In contrast, a second vehicle may include a second ADAS, and include the proposed camera calibration system. A controller of the second vehicle may receive images from an in-cabin camera of the second vehicle with varying degrees of lighting, brightness, and/or contrast acquired by a DMS of the first vehicle. The controller may perform an extrinsic calibration of the in-cabin camera of the second vehicle using a trained DL calibration model of the proposed camera calibration system. After the extrinsic calibration, the second ADAS may be more accurate in identifying feature points of images of the driver, as a result of performing the extrinsic calibration. The increase in the accuracy of feature point detection may result in an increased performance of the neural network model of the ADAS, whereby a level of alertness of a driver of the second vehicle may be more accurately predicted by the second ADAS than the first ADAS. As a result of the level of alertness of a driver of the second vehicle being accurately predicted, the ADAS may intervene in a timely manner to increase the driver's level of alertness. For example, the ADAS may play music through a speaker of the vehicle, or decrease a temperature of a cabin of the second vehicle, or perform a different action. In this way, a quality of operation of the vehicle by the second driver and a driving performance of the second driver may be increased.

The disclosure also provides support for a method for performing an extrinsic calibration of a camera of a vehicle, the method comprising: receiving a plurality of images from the camera of the vehicle, detecting and describing a plurality of two-dimensional (2D) feature points of the images using a trained neural network model, mapping the detected 2D feature points to three-dimensional (3D) feature points stored in a feature point library generated using the trained neural network model, estimating a set of extrinsic parameters of the camera using the mapped 3D feature points, performing the extrinsic calibration based on the set of extrinsic parameters. In a first example of the method, images acquired with the camera are used by an Advanced Driver Assistance System (ADAS) of the vehicle after calibration of the camera. In a second example of the method, optionally including the first example, the plurality of images includes a first dataset of images of a reference object acquired with constrained camera poses or unconstrained camera poses of the camera, and a second dataset of images of the reference object acquired with unconstrained camera poses of the camera. In a third example of the method, optionally including one or both of the first and second examples, the reference object is a chessboard. In a fourth example of the method, optionally including one or more or each of the first through third examples, the neural network model has an encoder/decoder architecture including: a first decoder portion trained to detect 2D feature points in a pair of images of the plurality of images, a second decoder portion trained to predict descriptions of the detected 2D feature points, and a third, shared encoder portion trained to detect the 2D feature points and predict the descriptions of the detected 2D feature points, wherein the neural network model is jointly trained to detect the 2D feature points and predict the descriptions of the detected 2D feature points. In a fifth example of the method, optionally including one or more or each of the first through fourth examples, jointly training the neural network model to detect the 2D feature points in a pair of images and predict descriptions of the detected 2D feature points further comprises: using a feature point detector to label pixel locations of each image of the pair of images as feature points or background points and generate a description of each pixel location, back-propagating a loss from a first output of the first decoder portion, adjusting weights and biases of convolutional layers of the first decoder portion of the neural network model in accordance with a first loss function, using the labeled pixel positions as ground truth data, back-propagating a loss from a second output of the second decoder portion, adjusting weights and biases of convolutional layers of the second decoder portion of the neural network model in accordance with a second loss function, and back-propagating a loss from the first and second outputs and adjusting weights and biases of convolutional layers of the third, shared encoder portion of the neural network model in accordance with both of the first and the second loss functions. In a sixth example of the method, optionally including one or more or each of the first through fifth examples, the first loss function is a sigmoid cross-entropy loss function, and the second loss function is a triplet loss function based on a negative log likelihood loss, and adjusting the weights and biases of the convolutional layers of the second decoder portion in accordance with the second loss function further comprises: calculating a first distance between a first feature point of a first image of the pair of images and a second, matching feature point of a second image of the pair of images, calculating a second distance between a first background point or feature point in the first image and a second background point or feature point in the second image, the first background point or feature point having a distance greater than a threshold distance from the second background point or feature point, minimizing the first distance and maximizing the second distance using the triplet loss function. In a seventh example of the method, optionally including one or more or each of the first through sixth examples, the feature point detector is one of a scale-invariant feature transform (SIFT) algorithm and a chessboard detection algorithm. In an eighth example of the method, optionally including one or more or each of the first through seventh examples, each description is an n-length vector with float or integer values representing visual characteristics surrounding a respective feature point that distinguish the respective feature point from a different feature point. In a ninth example of the method, optionally including one or more or each of the first through eighth examples, using the feature point detector to label pixel locations of the image as feature points or background points further comprises: labeling a pixel location as a feature point in response to a probability outputted by the feature point detector of the pixel location being a feature point exceeding a threshold probability, and labeling the pixel location as a background point in response to the probability not exceeding the threshold probability. In a tenth example of the method, optionally including one or more or each of the first through ninth examples, the pair of images includes two images acquired with a same constrained camera pose. In an eleventh example of the method, optionally including one or more or each of the first through tenth examples, the pair of images includes a first image acquired with an unconstrained camera pose and a second image generated using a homography matrix. In a twelfth example of the method, optionally including one or more or each of the first through eleventh examples, generating the feature point library further comprises: using the trained DL calibration model to predict descriptions of 2D feature points detected in a pair of images of the second dataset, the 2D feature points detected by the trained DL calibration model, determining a relative camera pose between two images of the pair of images, matching 2D feature points and corresponding descriptions of the 2D feature points for the pair of images, performing a triangulation of matched feature points for the pair of images to establish respective 3D feature points including the corresponding descriptions, and storing the 3D feature points and the corresponding descriptions in the feature point library. In a thirteenth example of the method, optionally including one or more or each of the first through twelfth examples, mapping the detected 2D feature points to 3D feature points stored in the feature point library further comprises: using a first description of a first detected 2D feature point of an image to map the first detected 2D feature point to a 3D feature point stored in the feature point library, where the 3D feature point includes a second description of the 3D feature point, the second description within a threshold distance of the first description. In a fourteenth example of the method, optionally including one or more or each of the first through thirteenth examples, estimating the set of extrinsic parameters of the camera using the mapped 3D feature points further comprises: using the trained DL calibration model to detect 2D feature points in pairs of images and predict corresponding descriptions of the detected 2D feature points, identifying 3D feature points in the feature point library corresponding to the 2D feature points, based on the descriptions, and determining extrinsic parameters of the camera using a camera pose estimation algorithm based on intrinsic camera parameters, the 2D feature points and descriptions, and the 3D feature points and descriptions.

The disclosure also provides support for an extrinsic camera calibration system for a camera of a vehicle, comprising: a processor, and a non-transitory memory including instructions that when executed cause the processor to: receive a first plurality of images acquired with the camera, train a neural network model to detect two-dimensional (2D) feature points and generate descriptions for the detected 2D feature points, build a feature point library using the trained neural network model, the feature point library including three-dimensional (3D) feature points having similar descriptions as the detected 2D feature points, and deploy the trained neural network model and the feature point library at a driver monitoring system (DMS) of the vehicle, the DMS configured to: receive a plurality of images of a driver of the vehicle acquired with the camera, detect 2D feature points in the images of the driver and predict descriptions for the detected 2D feature points using the trained neural network model, map the detected 2D feature points to corresponding 3D feature points of the feature point library, estimate a set of extrinsic parameters of the camera based on the 3D feature points, and perform an extrinsic calibration of the camera using the estimated extrinsic parameters. In a first example of the system, the neural network model has an encoder/decoder architecture, including: a first decoder portion trained to detect 2D feature points in a pair of images of the plurality of images, a second decoder portion trained to predict descriptions of the detected 2D feature points, and a third, shared encoder portion trained to detect the 2D feature points and predict the descriptions of the detected 2D feature points, wherein the neural network model is jointly trained to detect the 2D feature points and predict the descriptions of the detected 2D feature points. In a second example of the system, optionally including the first example, training the neural network model to detect the 2D feature points and generate descriptions for the detected 2D feature points further comprises: using a feature point detector to label pixel locations of each image of the pair of images as feature points or background points and generate a description of each pixel location, back-propagating a first loss from a first output of the first decoder portion, adjusting weights and biases of convolutional layers of the first decoder portion of the neural network model in accordance with a first loss function, using the labeled pixel positions as ground truth data, back-propagating a second loss from a second output of the second decoder portion, adjusting weights and biases of convolutional layers of the second decoder portion of the neural network model in accordance with a second loss function, and back-propagating a third loss from the first and second outputs and adjusting weights and biases of convolutional layers of the third, shared encoder portion of the neural network model in accordance with both of the first and the second loss functions. In a third example of the system, optionally including one or both of the first and second examples, the first loss function is a sigmoid cross-entropy loss function, and the second loss function is a triplet loss function based on a negative log likelihood loss, and adjusting the weights and biases of the convolutional layers of the second decoder portion in accordance with the second loss function further comprises: calculating a first distance between a first feature point of a first image of the pair of images and a second, matching feature point of a second image of the pair of images, calculating a second distance between a first background point or feature point in the first image and a second background point or feature point in the second image, the first background point or feature point having a distance greater than a threshold distance from the second background point or feature point, minimizing the first distance and maximizing the second distance using the triplet loss function.

The disclosure also provides support for a method, comprising: estimating a set of extrinsic parameters of a camera of a vehicle based on determining three-dimensional (3D) feature points on a driver of the vehicle, the 3D feature points corresponding to two-dimensional (2D) feature points of an image of the driver acquired by the camera, the 2D feature points detected by a trained neural network model, wherein the neural network model is trained jointly to detect 2D feature points in images acquired by the camera and predict descriptions of the 2D feature points, and the 2D feature points are mapped to the 3D feature points based on the predicted descriptions, and performing an extrinsic calibration of the camera using the set of extrinsic parameters.

The descriptions of the various embodiments described herein have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the terms ML model, DL calibration model, neural network, and vehicle operational data are intended to include all such new technologies a priori.

The terms “comprises”, “comprising”, “includes”, “including”, “having” and their conjugates mean “including but not limited to”. This term encompasses the terms “consisting of” and “consisting essentially of”.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of described herein may include a plurality of “optional” features unless such features conflict.

It is appreciated that certain features of embodiments described herein, which are, for clarity, described in the context of separate embodiments, may also be provided in combination in a single embodiment. Conversely, various features of embodiments described herein, which are, for brevity, described in the context of a single embodiment, may also be provided separately or in any suitable sub-combination or as suitable in any other embodiment described herein. Certain features described in the context of various embodiments are not to be considered essential features of those embodiments, unless the embodiment is inoperative without those elements.

Although the embodiments described herein have been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the embodiments described herein. To the extent that section headings are used, they should not be construed as necessarily limiting. In addition, any priority document(s) of this application is/are hereby incorporated herein by reference in its/their entirety.

1. A method for performing an extrinsic calibration of a camera of a vehicle, the method comprising:
receiving a plurality of images from the camera of the vehicle;
detecting and describing a plurality of two-dimensional (2D) feature points of the images using a trained neural network model;
mapping the detected 2D feature points to three-dimensional (3D) feature points stored in a feature point library generated using the trained neural network model;
estimating a set of extrinsic parameters of the camera using the mapped 3D feature points;
performing the extrinsic calibration based on the set of extrinsic parameters.

2. The method of claim 1, wherein images acquired with the camera are used by an Advanced Driver Assistance System (ADAS) of the vehicle after calibration of the camera.

3. The method of claim 1, wherein the plurality of images includes a first dataset of images of a reference object acquired with constrained camera poses or unconstrained camera poses of the camera; and a second dataset of images of the reference object acquired with unconstrained camera poses of the camera.

4. The method of claim 3, wherein the reference object is a chessboard.

5. The method of claim 1, wherein the neural network model has an encoder/decoder architecture including:
a first decoder portion trained to detect 2D feature points in a pair of images of the plurality of images;
a second decoder portion trained to predict descriptions of the detected 2D feature points; and
a third, shared encoder portion trained to detect the 2D feature points and predict the descriptions of the detected 2D feature points;
wherein the neural network model is jointly trained to detect the 2D feature points and predict the descriptions of the detected 2D feature points.

6. The method of claim 5, wherein jointly training the neural network model to detect the 2D feature points in a pair of images and predict descriptions of the detected 2D feature points further comprises:
using a feature point detector to label pixel locations of each image of the pair of images as feature points or background points and generate a description of each pixel location;
back-propagating a loss from a first output of the first decoder portion, adjusting weights and biases of convolutional layers of the first decoder portion of the neural network model in accordance with a first loss function, using the labeled pixel positions as ground truth data;
back-propagating a loss from a second output of the second decoder portion, adjusting weights and biases of convolutional layers of the second decoder portion of the neural network model in accordance with a second loss function; and
back-propagating a loss from the first and second outputs and adjusting weights and biases of convolutional layers of the third, shared encoder portion of the neural network model in accordance with both of the first and the second loss functions.

7. The method of claim 6, wherein the first loss function is one of a sigmoid cross-entropy loss function and a softmax negative log likelihood loss function, and the second loss function is a triplet loss function based on a negative log likelihood loss, and adjusting the weights and biases of the convolutional layers of the second decoder portion in accordance with the second loss function further comprises:
calculating a first distance between a first feature point of a first image of the pair of images and a second, matching feature point of a second image of the pair of images;
calculating a second distance between a first background point or feature point in the first image and a second background point or feature point in the second image, the first background point or feature point having a distance greater than a threshold distance from the second background point or feature point;
minimizing the first distance and maximizing the second distance using the triplet loss function.

8. The method of claim 6, wherein the feature point detector is one of a scale-invariant feature transform (SIFT) algorithm and a chessboard detection algorithm.

9. The method of claim 6, wherein each description is an n-length vector with float or integer values representing visual characteristics surrounding a respective feature point that distinguish the respective feature point from a different feature point.

10. The method of claim 6, wherein using the feature point detector to label pixel locations of the image as feature points or background points further comprises:
labeling a pixel location as a feature point in response to a probability outputted by the feature point detector of the pixel location being a feature point exceeding a threshold probability, and labeling the pixel location as a background point in response to the probability not exceeding the threshold probability.

11. The method of claim 6, wherein the pair of images includes two images acquired with a same constrained camera pose.

12. The method of claim 6, wherein the pair of images includes a first image acquired with an unconstrained camera pose and a second image generated using a homography matrix.

13. The method of claim 3, wherein generating the feature point library further comprises:
using the trained DL calibration model to predict descriptions of 2D feature points detected in a pair of images of the second dataset, the 2D feature points detected by the trained DL calibration model;
determining a relative camera pose between two images of the pair of images;
matching 2D feature points and corresponding descriptions of the 2D feature points for the pair of images;
performing a triangulation of matched feature points for the pair of images to establish respective 3D feature points including the corresponding descriptions; and
storing the 3D feature points and the corresponding descriptions in the feature point library.

14. The method of claim 1, wherein mapping the detected 2D feature points to 3D feature points stored in the feature point library further comprises:
using a first description of a first detected 2D feature point of an image to map the first detected 2D feature point to a 3D feature point stored in the feature point library, where the 3D feature point includes a second description of the 3D feature point, the second description within a threshold distance of the first description.

15. The method of claim 1, wherein estimating the set of extrinsic parameters of the camera using the mapped 3D feature points further comprises:
using the trained DL calibration model to detect 2D feature points in pairs of images and predict corresponding descriptions of the detected 2D feature points;
identifying 3D feature points in the feature point library corresponding to the 2D feature points, based on the descriptions; and
determining extrinsic parameters of the camera using a camera pose estimation algorithm based on intrinsic camera parameters, the 2D feature points and descriptions, and the 3D feature points and descriptions.

16. An extrinsic camera calibration system for a camera of a vehicle, comprising:
a processor; and
a non-transitory memory including instructions that when executed cause the processor to:
receive a first plurality of images acquired with the camera;
train a neural network model to detect two-dimensional (2D) feature points and generate descriptions for the detected 2D feature points;
build a feature point library using the trained neural network model, the feature point library including three-dimensional (3D) feature points having similar descriptions as the detected 2D feature points; and
deploy the trained neural network model and the feature point library at a driver monitoring system (DMS) of the vehicle, the DMS configured to:
receive a plurality of images of a driver of the vehicle acquired with the camera;
detect 2D feature points in the images of the driver and predict descriptions for the detected 2D feature points using the trained neural network model;
map the detected 2D feature points to corresponding 3D feature points of the feature point library;
estimate a set of extrinsic parameters of the camera based on the 3D feature points; and
perform an extrinsic calibration of the camera using the estimated extrinsic parameters.

17. The extrinsic camera calibration system of claim 16, wherein the neural network model has an encoder/decoder architecture, including:
a first decoder portion trained to detect 2D feature points in a pair of images of the plurality of images;
a second decoder portion trained to predict descriptions of the detected 2D feature points; and
a third, shared encoder portion trained to detect the 2D feature points and predict the descriptions of the detected 2D feature points;
wherein the neural network model is jointly trained to detect the 2D feature points and predict the descriptions of the detected 2D feature points.

18. The extrinsic camera calibration system of claim 17, wherein training the neural network model to detect the 2D feature points and generate descriptions for the detected 2D feature points further comprises:
using a feature point detector to label pixel locations of each image of the pair of images as feature points or background points and generate a description of each pixel location;
back-propagating a first loss from a first output of the first decoder portion, adjusting weights and biases of convolutional layers of the first decoder portion of the neural network model in accordance with a first loss function, using the labeled pixel positions as ground truth data;
back-propagating a second loss from a second output of the second decoder portion, adjusting weights and biases of convolutional layers of the second decoder portion of the neural network model in accordance with a second loss function; and
back-propagating a third loss from the first and second outputs and adjusting weights and biases of convolutional layers of the third, shared encoder portion of the neural network model in accordance with both of the first and the second loss functions.

19. The extrinsic camera calibration system of claim 18, wherein the first loss function is a sigmoid cross-entropy loss function, and the second loss function is a triplet loss function based on a negative log likelihood loss, and adjusting the weights and biases of the convolutional layers of the second decoder portion in accordance with the second loss function further comprises:
calculating a first distance between a first feature point of a first image of the pair of images and a second, matching feature point of a second image of the pair of images;
calculating a second distance between a first background point or feature point in the first image and a second background point or feature point in the second image, the first background point or feature point having a distance greater than a threshold distance from the second background point or feature point;
minimizing the first distance and maximizing the second distance using the triplet loss function.

20. A method, comprising:
estimating a set of extrinsic parameters of a camera of a vehicle based on determining three-dimensional (3D) feature points on a driver of the vehicle, the 3D feature points corresponding to two-dimensional (2D) feature points of an image of the driver acquired by the camera, the 2D feature points detected by a trained neural network model, wherein the neural network model is trained jointly to detect 2D feature points in images acquired by the camera and predict descriptions of the 2D feature points, and the 2D feature points are mapped to the 3D feature points based on the predicted descriptions; and
performing an extrinsic calibration of the camera using the set of extrinsic parameters.
